(19) United States
(12) Patent Application Publication
(10) Pub. No.: US 2022/0019590 A1
(43) Pub. Date: Jan. 20, 2022

(54) SWIFT QUERY ENGINE AND METHOD THEREFORE

(71) Applicant: AFFINIO INC., Halifax (CA)

(72) Inventor: Stephen James Frederic Hankinson, Hammonds Plains (CA)

(21) Appl. No.: 17/375,902

(22) Filed: Jul. 14, 2021

Related U.S. Application Data
(63) Continuation-in-part of application No. 17/243,512, filed on Apr. 28, 2021.
(60) Provisional application No. 63/051,591, filed on Jul. 14, 2020.
(60) Provisional application No. 63/051,591, filed on Jul. 14, 2020.

(51) Int. Cl. G06F 16/2455; G06F 16/22; G06F 16/2457

(52) U.S. Cl. CPC G06F 16/24558; G06F 16/24578; G06F 16/24566; G06F 16/2237

(57) ABSTRACT

A method of realizing a scalable fast query engine randomly shuffles object vectors of a massive array of object vectors to produce a sorted array of object vectors, each object vector containing a respective number of keys of a massive set of predefined keys, and inverts the sorted array, with ordered mapping, onto a set of key-specific arrays of objects. Upon receiving a query, a query-specific array of objects is formed from selected key-specific arrays corresponding to specific keys stated in the query. In response to the query, a target set of objects is formed to include the query-specific set and selected objects of key-specific sets of high intersection levels with the query-specific set. The method identifies candidate key-specific arrays from the entire set of key-specific arrays then determines precise, or exact, intersection levels of the candidate key-specific arrays with the query-specific array.

### CROSS-REFERENCE TO RELATED APPLICATIONS

The present application claims the benefit of U.S. provisional application 63/051,591 entitled “Swift Insight-Engine Processing Massive Data”, filed Jul. 14, 2020, and also claims the benefit from U.S. patent application Ser. No. 17/243,512 entitled “Method and System for Secure Distributed Software-Service” filed Apr. 28, 2021, the entire contents of which are incorporated herein by reference.

### FIELD OF THE INVENTION

The invention relates to analysis of massive data to obtain specific information in real time. In particular, the invention is directed to scalable, fast, and thorough query engines.

### BACKGROUND

Several techniques for analysing raw data to extract useful information for a variety of applications are known in the art. As the size of raw data increases, the requisite computational effort increases rendering response to analysis request in real time a difficult task. There is a need, therefore, to explore methods for fast real-time analysis of massive data without engaging numerous computing devices.

### SUMMARY

In accordance with one aspect, the invention provides a method of selecting a target set of objects. The method is implemented at a query engine employing at least one processor and comprises processes of acquiring an array of N objects, each object associated with a respective object vector comprising a respective number of keys from a set of predefined keys, and randomly shuffling the N objects to produce a sorted array of objects. Each object is identified according to position in the sorted array. The sorted array of objects is inverted where each object is placed in corresponding key-specific arrays based on content of a corresponding object vector.

Upon receiving a query stating a number of keys belonging to a set of predefined keys, a query-specific array of objects is formed to include contents of selected key-specific arrays corresponding to query-stated keys.

An intersection level of each key-specific array, excluding the selected key-specific arrays, with the query-specific array, is determined, and a target set of objects is formed to include the query-specific array and a subset of at least one key-specific array having an intersection level with the query-specific array exceeding a predefined lower bound.

The query-specific array may be formed as a union of the selected key-specific arrays or to include only each object of the selected key-specific arrays that belongs to at least two key-specific arrays of the selected key-specific arrays.

The process of determining an intersection level comprises computing a critical number of samples according to cardinality of a key-specific array and counting a first number of intersections corresponding to the critical number of samples. Where the first number, for the key-specific array, exceeds a specified intersection lower bound, counting intersection continues to determine an actual number of intersections. Otherwise, the key-specific array is considered irrelevant to the query and is discarded.

According to an implementation, the critical number of samples is determined as γ*=┌(logₑ η)/logₑ (1.0−ρ)┐, ρ being a ratio of the specified intersection lower bound to cardinality of a key-specific array under consideration, η being a deciding probability, selected to be less than 0.01, that none of γ* randomly selected objects of the key-specific array is found in the query-specific array.

According to another implementation, the critical number of samples is determined from a recursion:

π=1, and

πⱼ←πⱼ₋₁×(1−r/(Ω−j+1)), j>0, π_{γ}<η,

where Ω denotes cardinality of the key-specific array under consideration and η denotes a deciding probability, selected to be less than 0.01, that none of γ randomly selected objects of the key-specific array is found in the query-specific array.

The process of ordered mapping comprises a step of selecting objects of the sorted array sequentially, then for each selected object and for each indicated key in a respective object vector, an identifier of a position of the object in the sorted array is inserted at a first free position of a respective key-specific array.

The query engine uses either of two methods for fast determination of an intersection level of a key-specific array and a query-specific array.

The first method, for fast determination of an intersection, segments the query-specific array and each key-specific array into Λ buckets, each bucket corresponding to λ objects so that Λ×λ≥N. A first bitmap of the query-specific array of objects is generated and a second bitmap of a selected key-specific array is generated. A logical AND operation of designated buckets of the first bitmap and corresponding buckets of the second bitmaps is performed and the intersection level based on the outcome of the AND operation is then determined.

The second method, for fast determination of an intersection, initializes a first pointer to the key-specific array to 0, initializes a second pointer to the query-specific array to 0, then recursively execute processes of:
(a) comparing a first entry in the key-specific array corresponding to the first pointer with a second entry in the query-specific array corresponding to the second pointer;
(b) advancing the first pointer subject to a determination that the first entry is less than the second entry;
(c) advancing the second pointer subject to a determination that the second entry is less than the first entry; and
(d) advancing the first pointer and the second pointer subject to a determination of equality of the first entry and the second entry.

In order to determine a target set of objects corresponding to the keys stated in the query, the query engine performs processes of:
ranking candidate key-specific arrays according to the levels of intersection with the query-specific array;
initializing a target set of objects as the query-specific array of objects;
determining a subset of a first key-specific array of highest intersection with the query-specific array comprising objects not included in the query-specific array;
forming a first augmented target array of objects to comprise objects of the query-specific array and the subset of a first key-specific array;
determining a subset of a second key-specific array of second highest intersection level with the query-specific array comprising objects not included in the first augmented target array; and
forming a second augmented target array of objects to comprise objects of the first augmented target array and the subset of a second key-specific array.

In accordance with another aspect, the invention provides a query engine comprising:
(1) a network interface configured to communicate with data sources and clients;
(2) a first module configured to randomly shuffle an acquired array of objects to produce a sorted array of objects and assign a rank of each object in the sorted array as a respective global identifier;
(3) a second module configured to perform ordered mapping of the sorted array of objects onto a set of key-specific arrays of objects so that each key-specific array contains global identifiers in an ascending order;
(4) a third module configured to generate a query-specific array of objects corresponding to key-words specified in a query;
(5) a fourth module configured to determine candidate key-specific arrays of objects based on intersection with the query-specific array of objects;
(6) a fifth module configured to form a set of target objects combining the query-specific array and selected candidate key-specific arrays of objects;
(7) a memory device storing the sorted array of objects, respective object vectors, and the key-specific arrays of objects; and
(8) at least one processor coupled to the network interface, first module, second module, third module, fourth module, and fifth module.

The first module generates unique random integers, each occurring once, in the range 0 to (N−1), uses the m^{th}-generated random integer, 0≤m<N, to index the acquired array of objects to read an original identifier of a respective object, and writes the original identifier in position m of the sorted array of object, m becoming the respective global identifier.

The second module selects objects of the sorted array sequentially, starting from index 0, then for each selected object, and for each indicated key in a respective object vector, an identifier of a position of each selected object is inserted in the sorted array at a first free position of a respective key-specific array.

To generate the query-specific array of objects, the third module determines one of two options:
(A) a union of the selected key-specific arrays of objects observing the ascending order of global identifiers; or
(B) the union determined in (A) excluding each object that belongs to only one key-specific array of the selected key-specific arrays of objects.

To determine candidate key-specific arrays of objects, the fourth module determines a critical number of samples according to cardinality of a key-specific array under consideration and counts a first number of objects belonging to both the key-specific array and the query-specific array based on selecting a number of objects of the key-specific array equal to the critical number of samples. Where the first number exceeds a specified intersection lower bound. The fourth module marks the key-specific array as a candidate key-specific array. Otherwise, the key-specific array is discarded as irrelevant to the query under consideration.

The query engine further comprises a sixth module configured to determine the critical number of samples as:

γ*=┌(logₑη)/logₑ(1.0−ρ)┐,
ρ being a ratio of the specified intersection lower bound to cardinality of a key-specific array, and η being a deciding probability, selected to be less than 0.01, that none of γ* randomly selected objects of the key-specific array is found in the query-specific array.

Alternatively, the sixth module may be further configured to determine the critical number, from a recursion:

π₀=1,

πⱼ←πⱼ₋₁×(1−r/(Ω−j+1)), j>0, π_{γ}<η,
where Ω denotes cardinality of a key-specific array, and η denotes a deciding probability, selected to be less than 0.01, that none of γ randomly selected objects of a key-specific array is found in the query-specific array.

For fast determination of an intersection of a key-specific array and a query-specific array, the fourth module is further configured to:
segment each array of objects into Λ buckets, each bucket corresponding to λ objects so that Λ×λ≥N, N being a total number of objects of the acquired array of objects; generate a first bitmap of the query-specific array of objects;
generate a second bitmap of a selected key-specific array of the set of key-specific arrays;
performs a logical AND operation of designated buckets of the first bitmap and corresponding buckets of the second bitmap; determine cardinality of an intersection set
determine an intersection level based on the outcome of the AND operation.

Alternatively, for fast determination of an intersection of a key-specific array and a query-specific array, the fourth module is further configured to initialize a first pointer to the key-specific array to 0, initialize a second pointer to the query-specific array to 0, then recursively:
(i) compare a first entry in the key-specific array corresponding to the first pointer with a second entry in the query-specific array corresponding to the second pointer;
(ii) advance the first pointer subject to a determination that the first entry is less than the second entry;
(iii) advance the second pointer subject to a determination that the second entry is less than the first entry; and
(iv) advance the first pointer and the second pointer subject to a determination of equality of the first entry and the second entry.

To form the set of target objects, the fifth module ranks the candidate key-specific arrays according to levels of intersection with the query-specific array and determines a union of the query-specific array and at least one of the candidate key-specific arrays selected according to intersection level.

### BRIEF DESCRIPTION OF THE DRAWINGS

Embodiments of the present invention will be further described with reference to the accompanying exemplary drawings, in which:

FIG. 1 is an overview of a query-processing system, in accordance with an embodiment of the present invention;

FIG. 2 illustrates the plurality of objects and the key-specific sets, for use in an embodiment of the present invention;

FIG. 3 illustrates an exemplary query;

FIG. 4 illustrates four key-specific sets of objects;

FIG. 5 illustrates a master set of objects formed as a union of four sets of objects, in accordance with an embodiment of the present invention;

FIG. 6 illustrates a master set combining all overlapping subsets of the four sets of objects, in accordance with an embodiment of the present invention;

FIG. 7 illustrates processes of generating a response to a specific query, including a process of coarse filtering and fine filtering of key-specific sets of objects, in accordance with an embodiment of the present invention;

FIG. 8 illustrates a first implementation of the query-processing system of FIG. 1, in accordance with an embodiment of the present invention;

FIG. 9 illustrates dependence of requisite processing effort for determining a coefficient of similarity of two sets of objects on permissible estimation error;

FIG. 10 illustrates dependence of the number of candidate-sets on the permissible estimation error;

FIG. 11 illustrates a scheme of random shuffling and identifier translation of the plurality of objects, for use in an embodiment of the present invention;

FIG. 12 illustrates exemplary key-specific sets of objects;

FIG. 13 illustrates an exemplary sorted array of object vectors;

FIG. 14 illustrates inversion of the sorted array of FIG. 13 in the form of key-specific sets of objects;

FIG. 15 illustrates Pairwise intersection levels of the key-specific sets;

FIG. 16 illustrates intersection of individual key-specific sets with a first query-specific set of objects;

FIG. 17 Intersection of individual key-specific sets with a second query-specific set of objects;

FIG. 18 illustrates pairwise intersection levels of the key-specific sets of large cardinalities;

FIG. 19 illustrates a method of selecting a set of target objects in response to a query, in accordance with an embodiment of the present invention;

FIG. 20 illustrates a second implementation of the query-processing system of FIG. 1, in accordance with an embodiment of the present invention;

FIG. 21 illustrates the process of generating an array of sorted object vectors, in accordance with an embodiment of the present invention;

FIG. 22 illustrates object-identifier translation based on the scheme of random shuffling of FIG. 11 and key-specific sets of objects of FIG. 12, in accordance with an embodiment of the present invention;

FIG. 23 illustrates a method of determining a critical sample size for fast estimation of set-intersection levels, in accordance with an embodiment of the present invention;

FIG. 24 illustrates processes of segmenting object sets into a specified upper bound of a number of buckets, in accordance with an embodiment of the present invention;

FIG. 25 illustrates a first method of determining set intersection, in accordance with an embodiment of the present invention;

FIG. 26 illustrates an exemplary scheme of segmenting sets of objects into buckets applied to a first set of translated object identifiers and a second set of translated object identifiers, in accordance with an embodiment of the present invention;

FIG. 27 illustrates an implementation of processes of FIG. 24 for selecting a number of buckets and contents per bucket, in accordance with an embodiment of the present invention;

FIG. 28 illustrates an example of buckets of a master set of objects of translated identifiers;

FIG. 29 illustrates another example of buckets of a key-specific set under consideration containing translated identifiers;

FIG. 30 illustrates buckets' content;

FIG. 31 illustrates a process of estimating intersection of two sets for use in the method of FIG. 25;

FIG. 32 illustrates ordered comparison of sets to determine intersection

FIG. 33 illustrates a method of estimating a critical number of object samples (requisite sample size) of a selected key-specific set of objects to be used for determining the likelihood of a significant similarity of the selected key-specific set to a master set of objects, in accordance with an embodiment of the present invention;

FIG. 34 illustrates a second method of determining set intersection FIG. 35 illustrates a method of determining candidate key-specific sets of objects, in accordance with an embodiment of the present invention;

FIG. 36 illustrates criteria for implementation of the processes of FIG. 7, in accordance with an embodiment of the present invention;

FIG. 37 illustrates ordered mapping of a plurality of object vectors of keys onto a plurality of key-specific arrays of objects to enable swift determination of intersection levels, in accordance with an embodiment of the present invention;

FIG. 38 illustrates data organization for ordered mapping of a plurality of object vectors of keys onto a plurality of key-specific arrays of objects, in accordance with an embodiment of the present invention;

FIG. 39 illustrates a method for implementing the ordered mapping of FIG. 38, in accordance with an embodiment of the present invention;

FIG. 40 illustrates ranking target objects, in accordance with an embodiment of the present invention; and

FIG. 41 illustrates a configuration of a query engine based on the method of FIG. 19, in accordance with an embodiment of the present invention.

### NOTATION

N: Total number of objects (1000,000,000, for example)
Q: The total number of descriptor keys (1000000, for example), hence the total number of Key-specific sets of objects
Θ: Number of candidate key-specific sets of objects, Θ<Q
Φ: Number of eligible key-specific sets of objects, Φ<Θ
Λ: Upper bound of the number of buckets
λ: Upper bound of a number of objects per bucket, Λ×λ≥N

### REFERENCE NUMERALS

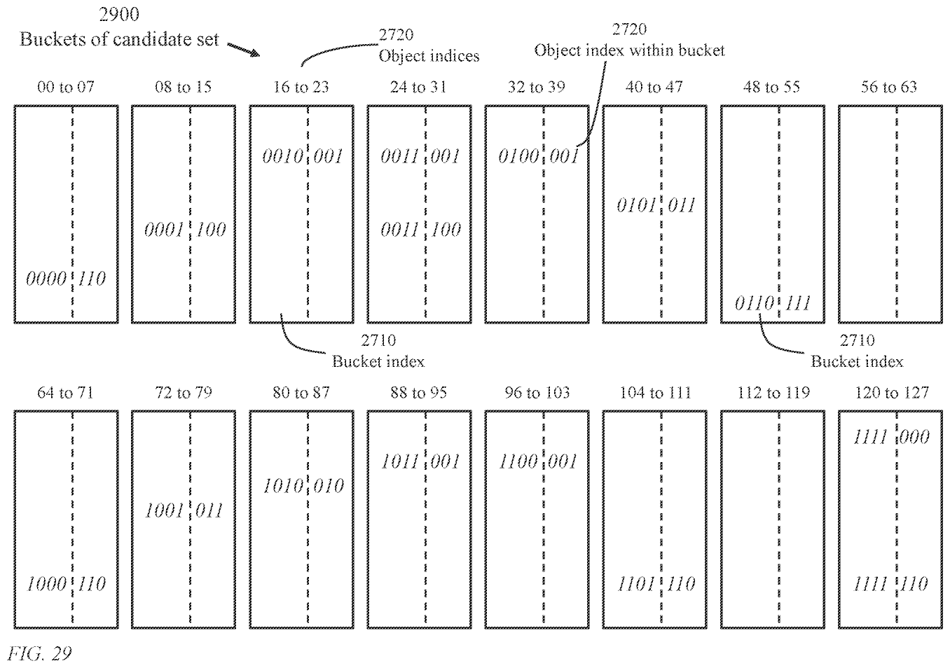

100: A query-processing system
110: A query from a client
120: Query engine
140: Descriptors of object population
160: Key-specific sets of object identifiers
180: Query result
210: An array of objects
212: Object identifier
214: Object descriptors
220: Key-specific sets of objects
230: Index of object in array 210
320: Query example
340: Query-result example
400: Query-specific relevant sets of objects
500: Master set of objects formed as a union of relevant sets
520: Union of four sets A, B, C, D
600: Master set of objects formed as overlapping subsets of four sets A, B, C, and D
700: Processes of responding to a query
710: A collection of Q key-specific sets, Q>>1
720: A process of coarse filtering to identify a subset of Θ of candidate key-specific sets of the Q key-specific sets based on an initial screening process to eliminate any key-specific set that is unlikely to be relevant to the query
730: Identified subset of candidate key-specific sets
740: A process of fine filtering to select eligible key-specific sets from the Θ candidate sets according to a stringent screening process.
750: A set of eligible key-specific sets
760: A process of ranking and sorting the eligible key-specific sets
770: Ranked selected objects
800: First implementation of query-processing system 100
810: Buffer holding queries 110 received from clients
821: Coarse hyperMinHash filter
822: Fine HyperMinHash filter
824: List of candidate key-specific sets
900: Exemplary dependence of requisite processing effort on permissible estimation error of a coefficient of similarity
1000: Exemplary dependence of count of candidate key-specific set on permissible estimation error of a coefficient of similarity
1110: Primary objects' identifiers
1120: Randomly shuffled primary objects' identifiers
1130: Secondary objects' identifiers
1140: Objects' descriptors corresponding to the primary objects' identifiers 1110
1150: Translation array indicating for each primary identifier in array 1110 a translated (secondary) identifier
1210: Exemplary key-specific sets of objects for a case of Q=9 and N=23, each set contains translated (secondary) object identifiers sorted in an ascending order
1220: Translated objects
1300: An exemplary sorted array of object vectors
1310: Global object identifiers
1320: A key-word (also referenced as “key”)
1340: Object vector of a variable number of keys
1400: Inversion of the sorted array 1300
1410: A plurality of predefined keys
1430: A plurality of key-specific sets of objects
1440: Individual key-specific sets of objects
1450: A global identifier of an object within a key-specific set
1460: Cardinality of individual key-specific sets of objects
1500: Pairwise intersection levels of the key-specific sets
1520: Cardinality of an intersection set of two key-specific sets
1600: Intersection of individual key-specific sets with a first query-specific set of objects
1620: A first query-specific set based on a union of key-specific sets of two keys specified in a query
1630: A plurality of key-specific sets of objects excluding the key-specific sets specified in the query
1700: Intersection of individual key-specific sets with a second query-specific set of objects
1720: A second query-specific set containing common objects of key-specific sets of two keys specified in a query
1800: Pairwise intersection levels of the key-specific sets of large cardinalities
1900: Basic method of selecting a set of target objects in response to a query
1910: A process of generating an array of N sorted object vectors (N may be of the order of a billion) where each object vector comprises a respective number of keys from a set of predefined keys
1920: A process of inverting the array of sorted object vectors to produce a number of key-specific sets of objects, which may be of significantly different cardinalities
1930: A process of receiving a query stating a number of keys from the set of predefined keys
1940: A process of generating a query-specific set of objects combining contents of key-specific sets corresponding to the query-stated keys
1950: A process of initializing a set of target objects to include only the query-specific set of objects
1960: A process of determining n intersection level of each key-specific set, excluding the key-specific sets that formed the query-specific set, with the query-specific set, in order to determine candidate key-specific sets that may qualify to join the set of target objects
1970: A process of selectively merging successful candidate key-specific sets with the query-specific set to form the set of target objects
2000: Second implementation of query-processing system 100
2010: Buffer holding queries 110 received from clients
2021: Process of identifying key-specific sets having at least a first-level of intersection with a master set as candidate sets
2022: Process of determining exact intersection of each candidate set with the master set
2024: List of candidate key-specific sets
2100: Details of process 1910
2110: A process of acquiring an array of N object vectors (N may be of the order of a billion) where each object vector comprises a respective number of keys from a set of predefined keys
2120: A process of random shuffling of the N objects
2200: Processes of object-identifier translation
2210: Process of accessing storage of N objects, N>>1
2220: Process of generating unique random integers in the range 0 to (N−1)
2230: Process of translating object identifiers according to the generated random integers
2300: A process of determining a critical sample size for fast estimation of set-intersection levels to filter out key-specific sets of weak relevance to the requirement of a query
2310: A step of specifying the cardinalities of two sets, a lower bound of cardinality of an intersection set, and a probability upper bound
2320: A step of terms initialization
2330: A step of determining a probability of not finding a common object in the two sets
2340: A step of determining completion or otherwise
2350: A step of randomly selecting a new sample and updating terms to account for reduced sample space due to non-replacement
2400: Process of segmenting object sets into buckets
2410: Process of determining a Master Set of objects according to key-specific sets corresponding to query-specified keys
2420: process of selecting an upper bound of a number of objects within a bucket of a specified number of buckets
2430: Process of segmenting the Master Set of objects into buckets
2440: Process of segmenting each key-specific set of objects into respective buckets
2500: A first method of determining set intersection
2510: A process of structuring a bitmap where the position of a bit corresponds to a global identifier of an object
2520: A process of generating a first bitmap of a query-specific set of objects
2530: A process of generating a second bitmap of a candidate key-specific set of objects
2540: A process of performing a logical AND operation of corresponding buckets of the first and second bitmaps
2550: A process of determining cardinality of an intersection set
2600: Process of segmenting sets of objects into buckets
2610: A first set of translated object identifiers
2620: A second set of translated object identifiers
2650: Buckets of the first set 2610 of translated object identifiers
2660: Buckets of the second set 2620 of translated object identifiers
2700: An implementation of process 2420 of selecting a number of buckets and contents per bucket
2710: Bucket index
2720: Range of object indices
2720: Object index within a bucket
2800: Buckets of a master set (query-specific set of objects)
2900: Buckets of a candidate set (key-specific set of objects)
3000: Buckets' content
3020: Bitmaps 2020 of the master set of FIG. 28
3040: Bit maps 2040 of the key-specific set of FIG. 29
3060: Intersection bitmaps
3120: A process of receiving an indication of a set of designated buckets and an intersection count threshold
3130: A step of selecting a bucket pair
3140: A step of determining cumulative count of common objects in the two buckets
3150: A step of determining continuing or terminating counting
3160: A step of reporting the count
3200: Ordered comparison of sets
3210: A query-specific set of objects
3212: Global object identifiers
3220: A key-specific set of objects
3240: A subset of set 3220
3300: A method of estimating a sample size
3400: A second method of determining set intersection
3410: A step of initializing an index j of an array G of ordered objects of a key-specific set, an index k of an array H of ordered objects of a query-specific set, and a count χ of an intersection set
3420: A process of verifying that index j is less than a predefined sample size γ that index k is not greater than the cardinality η of the query-specific set
3424: A process of reporting the resulting intersection count χ
3430: A process of comparing a global object identifier G(j) of the key-specific set to a global object identifier H(k) of the query-specific set
3434: A step of increasing index k and revisiting process 3420
3440: A process of determining equality or otherwise of G(j) and H(k)
3442: A step of increasing index j
3450: A process of comparing index j to the predefined sample size γ to branch to either process 3442 or process 3430
3460: A process of increasing the count χ
3462: A process of increasing index j and revisiting process 3434 then process 3420
3500: A method of determining candidate key-specific sets of objects (processes 3510, 3520, 3530, 3532, 3540, 3542, 3550, 3560, 3562, 3570, 3580)
3600: Process of ranking key-specific sets according to level of intersection with master set
3610: Process of estimating requisite sample size for realizing a first level of intersection.
3620: Process of filtering key-specific sets of objects according to first level of intersection to produce candidate key-specific sets
3630: Process of determining exact intersection level of each candidate key-specific set with the master set
3640: process of ranking key-specific sets according to intersection levels
3700: Notation relevant to ordered mapping of object vectors onto key-specific areas
3800: Data organization for ordered mapping of N object vectors of keys onto Q key-specific arrays of objects
3900: Method for implementing ordered mapping
3980: Produced key-specific arrays
4000: Ranking of target objects
4020: Query-specific set for a specific query
4030: Subset of a first key-specific set of highest intersection with the query-specific set
4035: First augmented target set of objects
4040: Subset of a second key-specific set of second highest intersection with the query-specific set
4045: Second augmented target set of objects
4050: Subset of a third key-specific set of third highest intersection with the query-specific
4055: Third augmented target set of objects
4100: Query engine configuration
4110: A network interface
4120: A module for randomly shuffling an array of object vectors to produce a sorted array of object vectors where an index of an object vector in the sorted array is used as a global object identifier
4130: A module for inverting the sorted array of object vectors to produce key-specific sets of objects
4140: A module for generating a query-specific set of objects corresponding to key-words specified in a query
4150: A module for determining a critical sample size and selecting parameters of a bitmap of a set of objects
4160: A module for determining candidate key-specific sets of objects based on intersection with a query-specific set of objects
4170: A module for determining candidate key-specific sets of objects for potential union with the key-specific set, and ranking the candidate key-specific set according to intersection levels
4180: A memory device (or separate memory devices) for storing the sorted array of object vectors and the key-specific sets of objects
4190: A processor, or generally an assembly of processors operating concurrently

### DETAILED DESCRIPTION

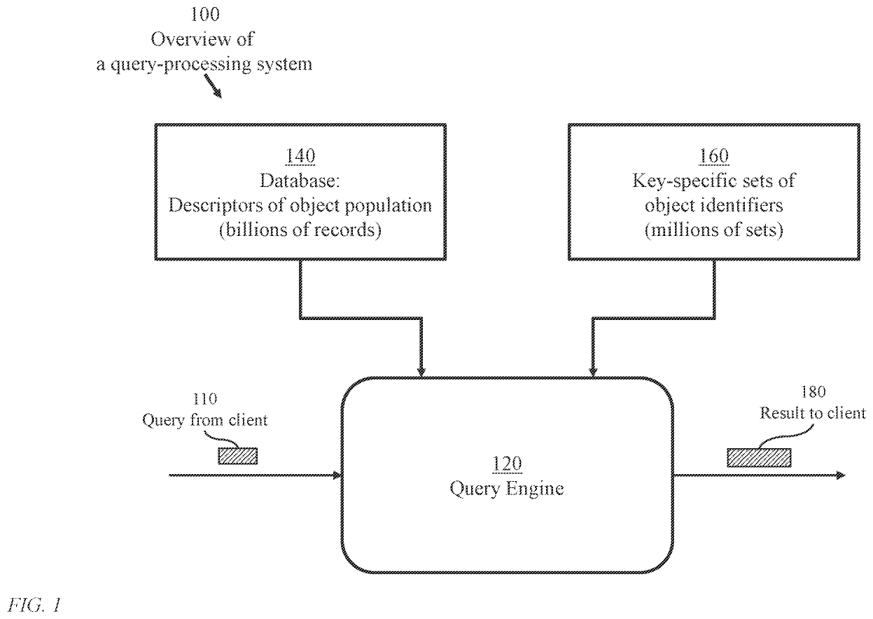

FIG. 1 is an overview 100 of a query-processing system comprising a query engine 120 configured to access a database 140 storing identifiers and descriptors of a plurality of objects and storage of a plurality of key-specific sets 160 of object identifiers. The query engine 120 configured to receive a query 110 from a client and return a list 180 of target objects of the plurality of objects. The query engine 120 employs at least one hardware processor for performing the processes described in the disclosure.

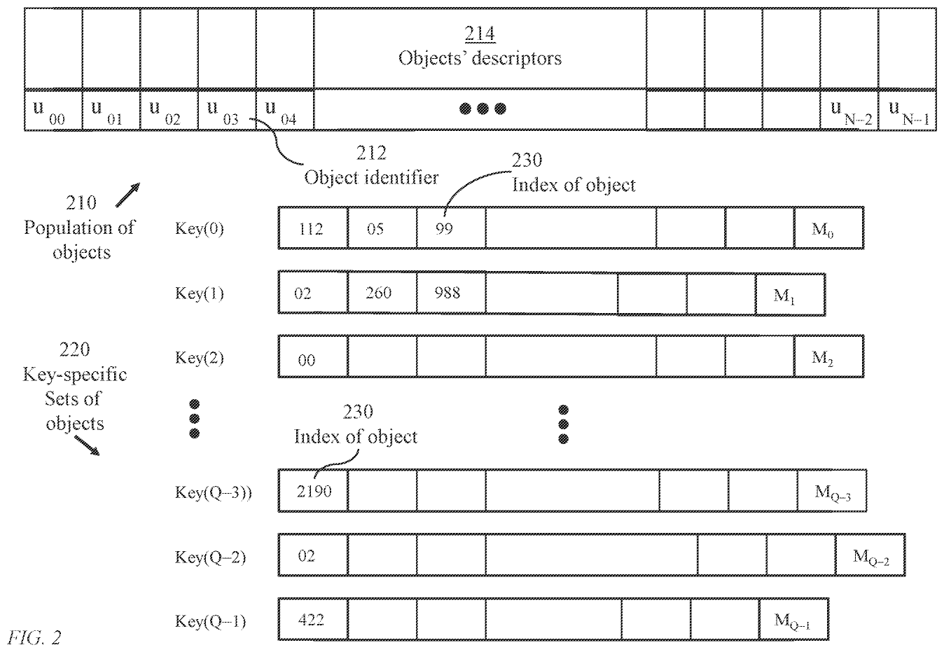

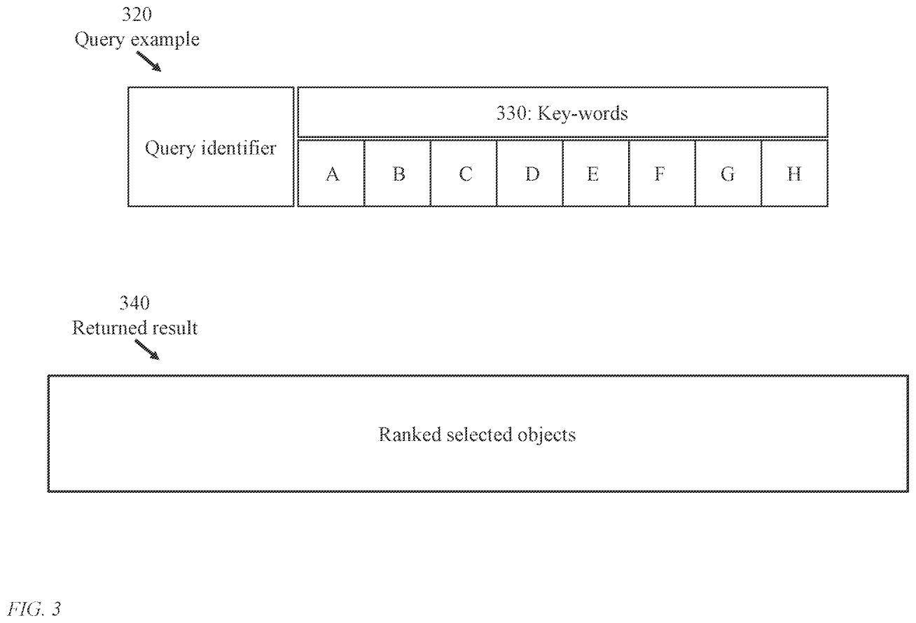

FIG. 2 illustrates the plurality of objects and the key-specific sets of objects 220. The plurality of objects comprises N objects, indexed as 0 to (N−1), labeled u₀ to u_{N-1}. Database 140 stores an identifier 212 and descriptors 214 of each object. Storage 160 contains data relevant to Q key-specific sets of objects. The storage maintains for each key-specific set an array of respective object indices 230. The number N of objects may be of the order of a billion and the number Q of key-specific sets may be of the order of several millions.

In the following, the terms “set” and “array” may be used synonymously if the order of respective elements is not of interest. The elements of a set of objects are identifiers of a number of objects. If the order of processing the objects of the set is of interest, then use of the term “array” is preferred. The terms “union” and “intersection” apply to both sets and arrays.

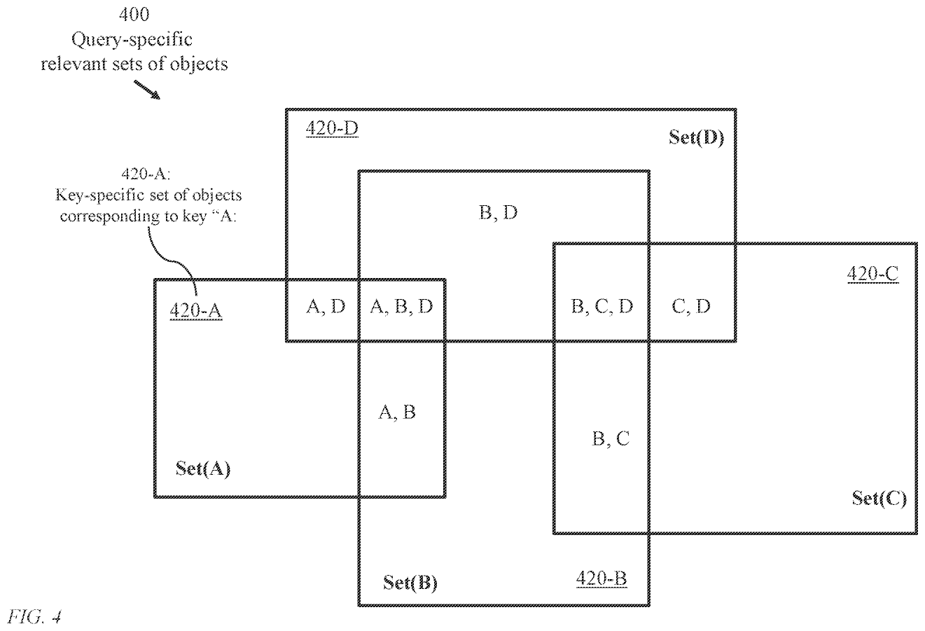

FIG. 3 illustrates an exemplary query 320 indicating predefined query parameters and respective specified values as well as a number of search keywords. The query engine provides a response 340 indicating relevant objects ranked according to a level of relevance.

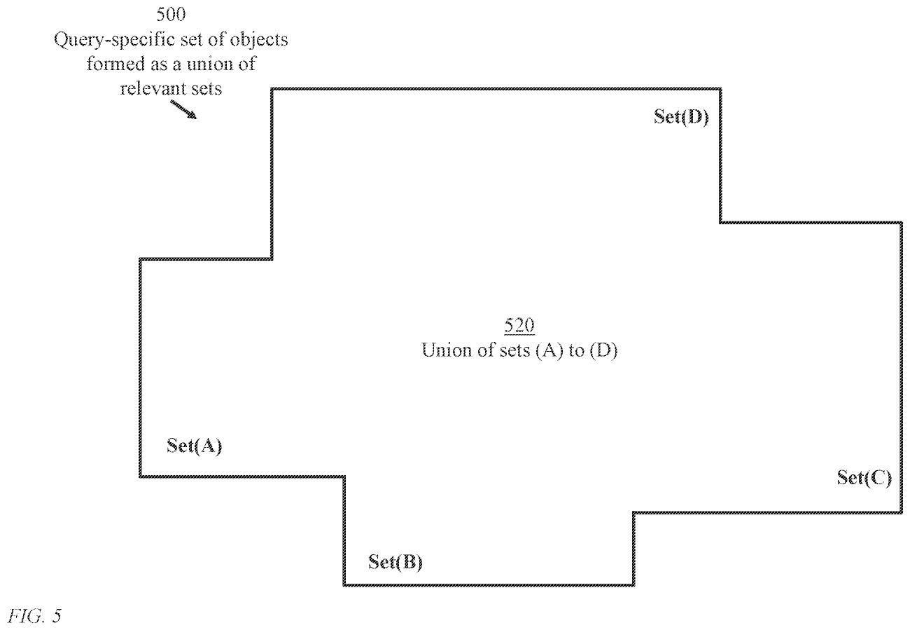

FIG. 4 illustrates four key-specific sets of objects, denoted “A”, “B”, “C”, and “D” corresponding to keywords (keys) stated in a specific query. A master set is determined based on the contents of the four key-specific sets. In the present specification, the term “key-specific set” and the general term “Master set” are used synonymously.

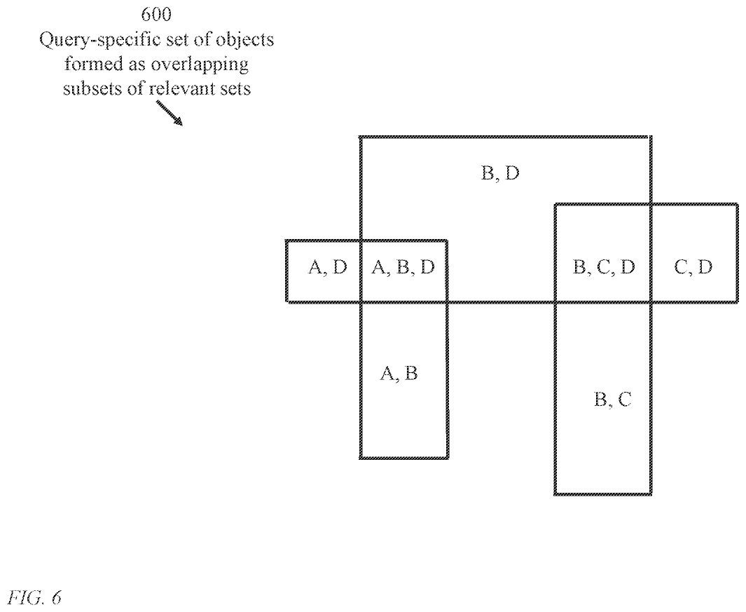

FIG. 5 illustrates a master set 500 based on the union 520 of the four sets.

FIG. 6 illustrates a master set combining all overlapping subsets of the four sets.

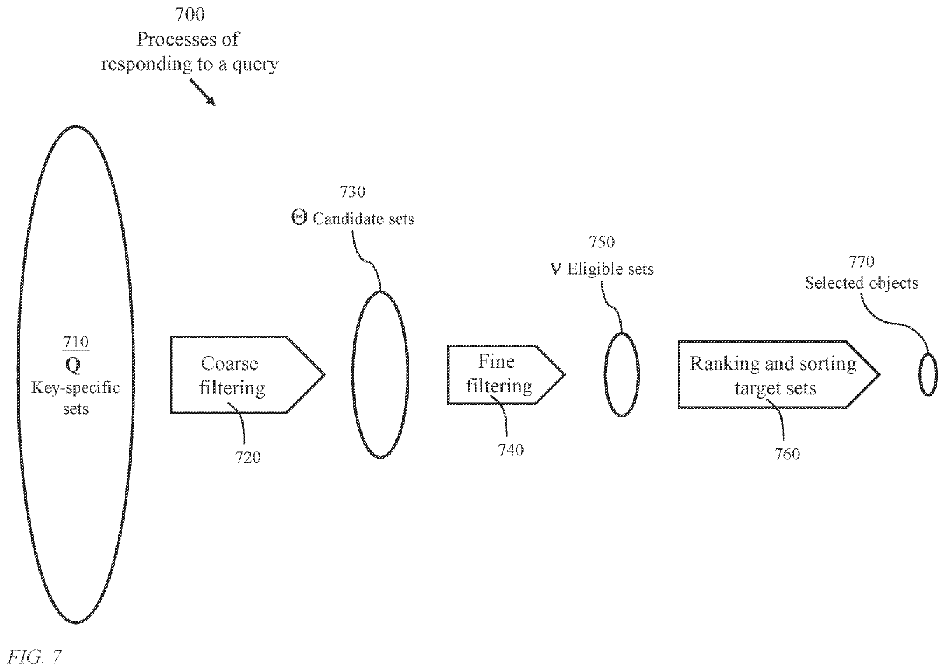

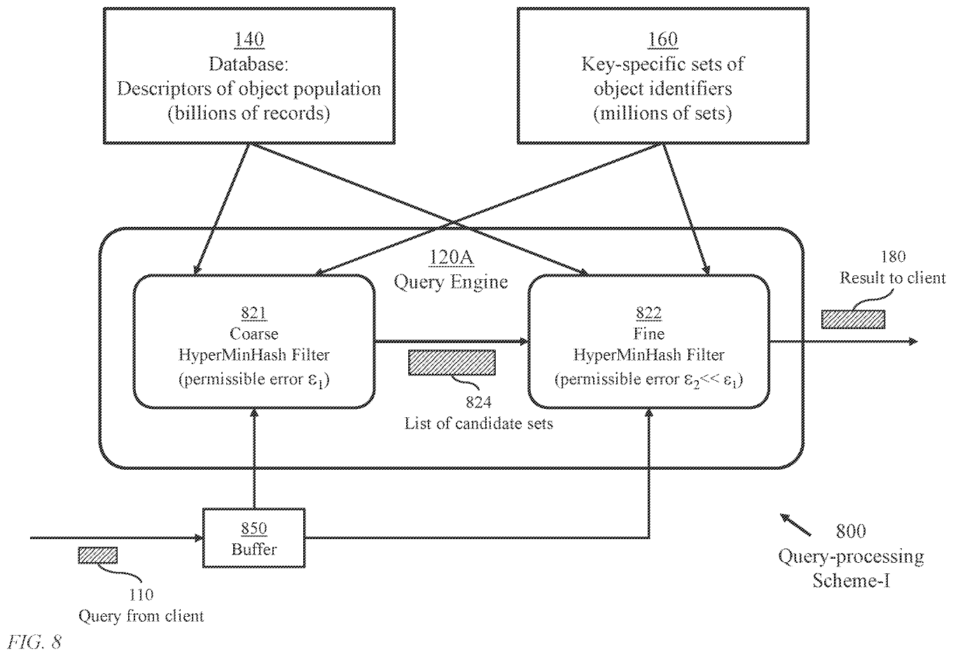

FIG. 7 illustrates processes 700 of generating a response to a specific query. A process 720 of coarse filtering selects a number Θ of candidate key-specific sets 730 from the Q key-specific sets 710 based on an initial screening process to eliminate any key-specific set that is unlikely to be relevant to the query. This is based on the size of a key-specific set under consideration or a high probability of dissimilarity to the master set. Either of two techniques, illustrated in FIG. 8 and FIG. 20, may be used for coarse filtering. The number Θ of candidate key-specific sets would be orders of magnitude smaller than the total number Q of sets. A process 740 of fine filtering selects a number v of eligible key-specific sets 750 from the Θ candidate sets 730 according to a stringent, computationally intensive, screening process. It is noted that while process 740 is computationally intensive, it is applied to a much smaller number of key-specific sets (Θ<<Q). The number v of eligible key-specific sets is, in turn, much smaller than Θ. The v eligible key-specific sets are ranked according to levels of similarity to the master set and sorted in order for clear interpretation.

FIG. 8 illustrates a first implementation 800 of the query-processing system of FIG. 1. A HyperMinHash filter 821 implements the coarse-filtering process 720. Filter 821 determines a level of similarity of each of the Q key-specific sets 710 to the master set based on applying the HyperMinHash algorithm with a relatively high permissible error ε₁. Filter 821 produces a list 824 of candidate key-specific sets corresponding to the Θ candidate sets 730 of FIG. 7. Filter 822 determines a level of similarity of each of the Θ key-specific sets 730 to the master set based on applying the HyperMinHash algorithm with a permissible error ε₂, which is much smaller than ε₁. Filter 822 produces the v eligible key-specific sets which is processed within the query engine 120A (implementing the ranking-sorting process 760) to produce result 180 which includes selected objects 770 of FIG. 7.

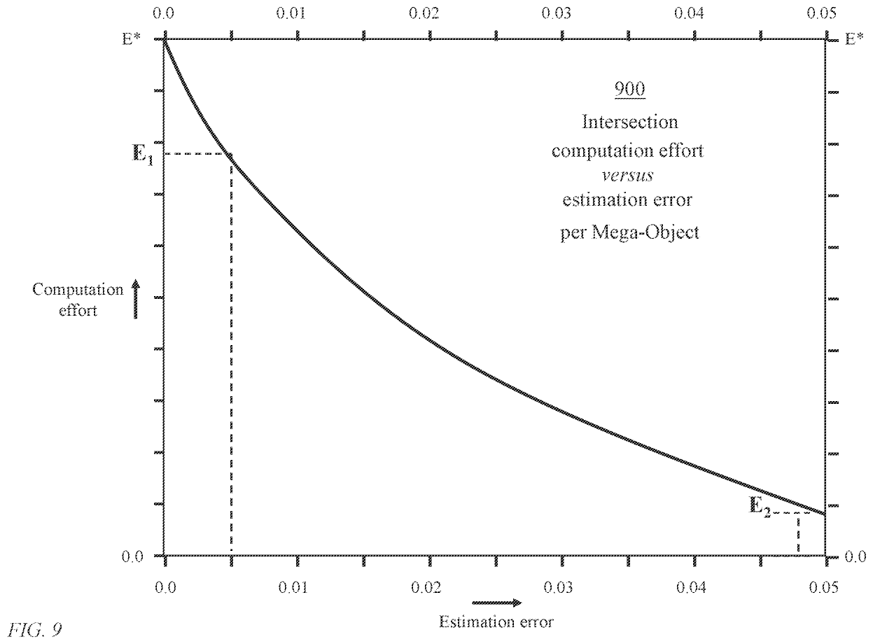

FIG. 9 illustrates dependence 900 of requisite processing effort for determining a coefficient of similarity of two sets of objects on permissible estimation error. Naturally, the computation effort depends on the total number of objects of the two sets. A hypothetical total number of one mega object may be used. The coefficient of similarity may be defined as the ratio of the number of common objects in the two sets to the number of objects of the union of the two sets. This ratio can be determined exactly, hence with an estimation error of zero. However, the requisite computation effort may be excessive. Methods of approximating the ratio to reduce the computation error are known. The computation effort for implementing approximate coefficient of similarity typically decreases significantly as the permissible estimation error increases. As illustrated in FIG. 9, the computation effort, denoted E₁, needed for determining a similarity coefficient with a permissible error of 0.005 is significantly larger than the computation effort, denoted E₂, needed for determining a similarity coefficient with a permissible error of 0.05. This property may be exploited to avoid unnecessary computations in a process of determining individual similarity coefficients of a large number (one million for example) of key-specific sets to a master set. In an initial coarse filtering process 720 (FIG. 7) the similarity coefficient of each of Q key-specific set to the master set may be determined with a permissible error of 0.05, for example. This results in weeding out a large proportion of the key-specific sets as being unlikely to bear any significant similarity to the master set. Thus, starting with one million key-specific sets (Q=1000000), the number Θ of candidate-sets 730 (FIG. 7) corresponding to a relatively large permissible error, may be of the order of 1000. Now, in a fine filtering process 740 (FIG. 7) the similarity coefficient of each of the Θ candidate key-specific sets to the master set may be determined with a much smaller permissible error of 0.005, for example, or may even be determined exactly as illustrated in FIG. 20.

The total computation effort for performing fine filtering process of all key-specific sets is Q×E₁. The total computation effort for performing the initial coarse filtering process is Q×E₂.

The total computation error for performing the fine filtering process is Θ×E₁. Typically, E₂<<E₁, and with a relatively large permissible error, Θ<<Q. Thus, (Q×E₂+Θ×E₁)<<Q×E₁.

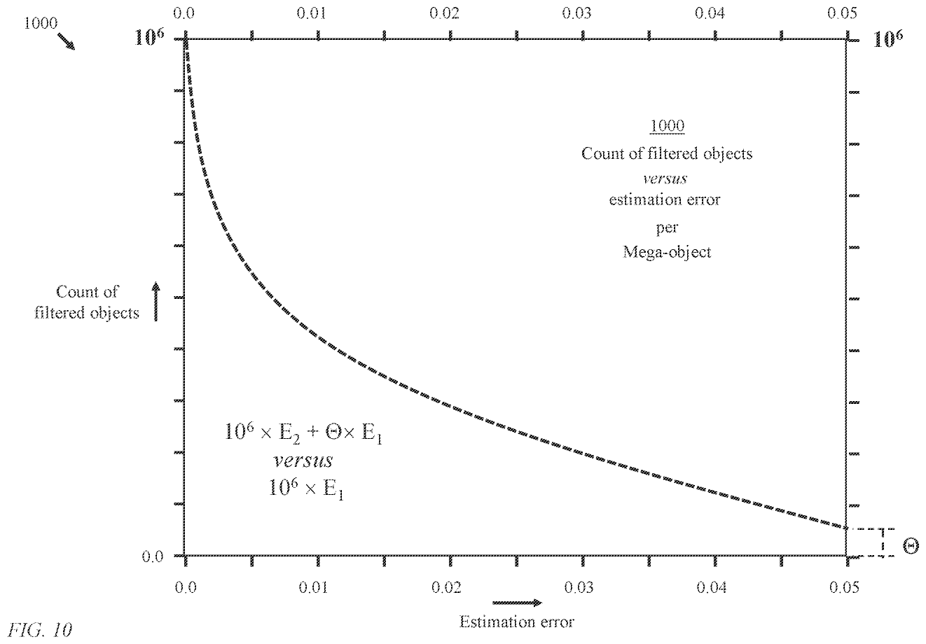

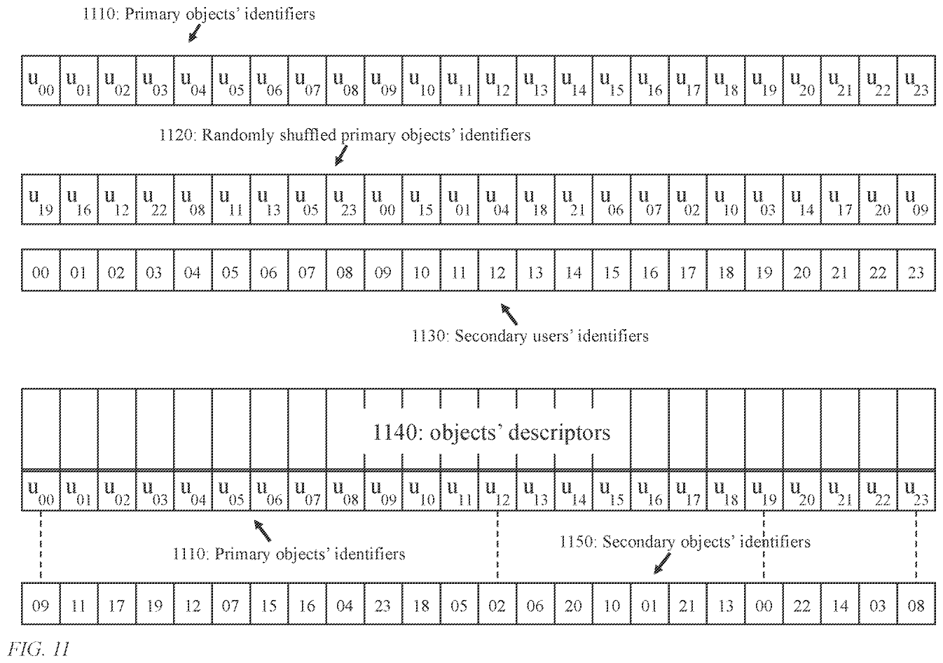

FIG. 10 illustrates variation 1000 of the number Θ of candidate sets as the permissible error is varied between 0.0 and 0.05. Naturally, zero permissible error implies that no filtering process takes place and the number of candidate sets equals the total number Q of key-specific sets.

FIG. 11 illustrates exemplary random shuffling and identifier translation of the plurality 210 of objects of FIG. 2 with N=24. Objects of array 1110 of primary (raw) object identifiers, labelled u₀ to u₂₃, are logically randomly shuffled and placed in array 1120 in the order u₁₉, u₁₆, . . . , u₀₉. For example, the object of primary object identifier u₁₉ is the first selected object and is placed in the first position of array 1130, the object of primary object identifier u₁₆ is second selected object and placed in the second position of array 1130, and so in.

The logically shuffled identifiers are translated into secondary object identifiers 0, 1, . . . 23 (reference 1130). Based on the shuffled pattern of arrays 1120 and 1130, translation array 1150 is generated to indicate for the index of each primary (raw) identifier in array 1110 a translated (secondary) identifier. Thus, primary identifier u₀₀ is translated to secondary identifier 09 of the same object. Primary identifier u₁₉ is translated to secondary identifier 0 of the same object. The secondary identifier of an object is basically the rank of the object in the logically shuffled array of objects. Array 1130 serves as an inverse translator of secondary identifiers to respective primary (raw) identifiers. Inverse translation is needed for reporting results of a query to a client initiating the query. At least one object descriptor 1140 of each object is stored in database 140 (FIG. 1). Consequently, the primary identifier of each object of each of the Q key-specific sets of objects 220 (FIG. 2) is translated into a respective secondary identifier.

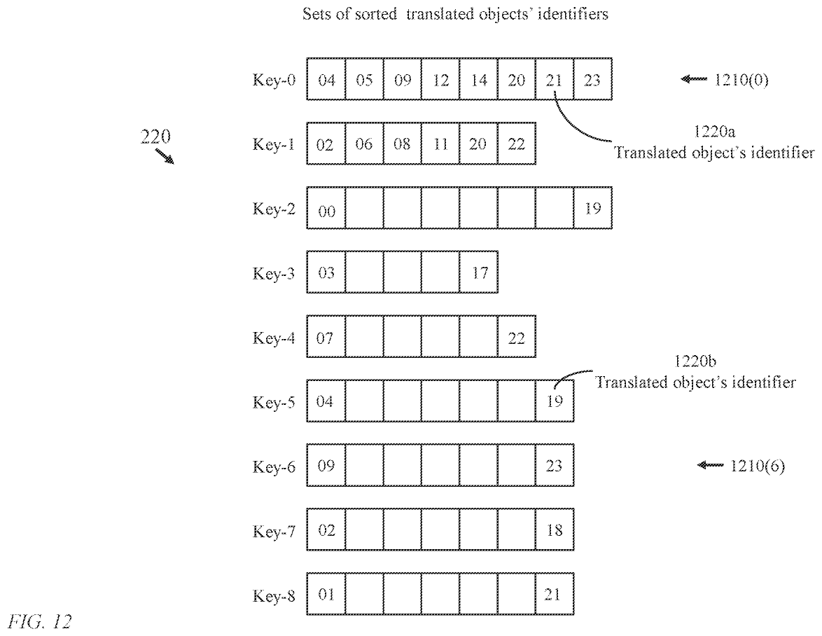

FIG. 12 illustrates exemplary key-specific sets 1210 of objects for the special case of Q=9 and N=23. Each key-specific set 1210 contains translated (secondary) object identifiers 1220 sorted in an ascending order.

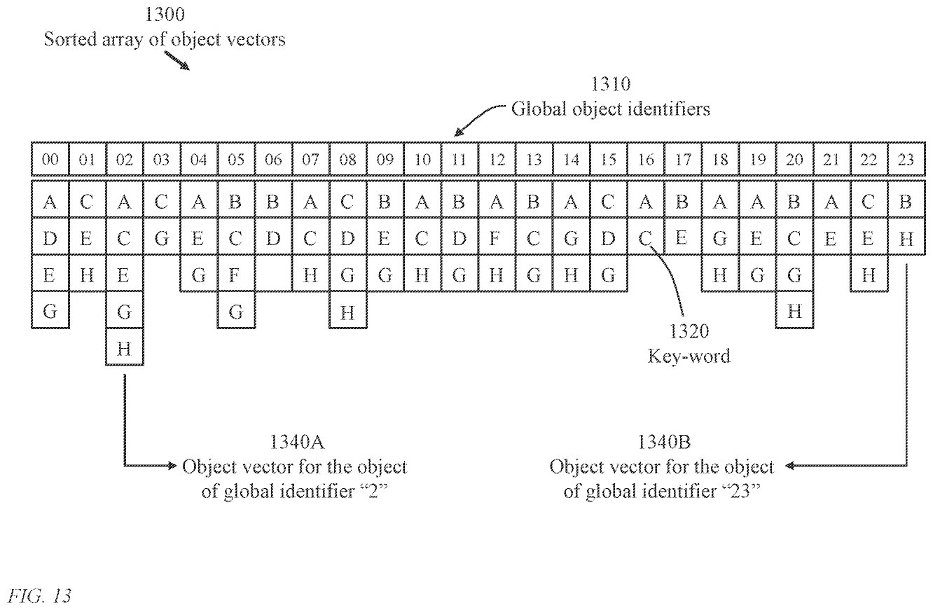

FIG. 13 illustrates an exemplary sorted array 1300 of object vectors for a case where N=24. The index 1310 of an object vector 1340 is a global object identifier of the object. Each object vector 1340 corresponding to an object includes a respective number of keys 1320 (keywords reflecting a property of the object) that characterize the object. An object vector may include an object name (e.g., a string of characters, not illustrated).

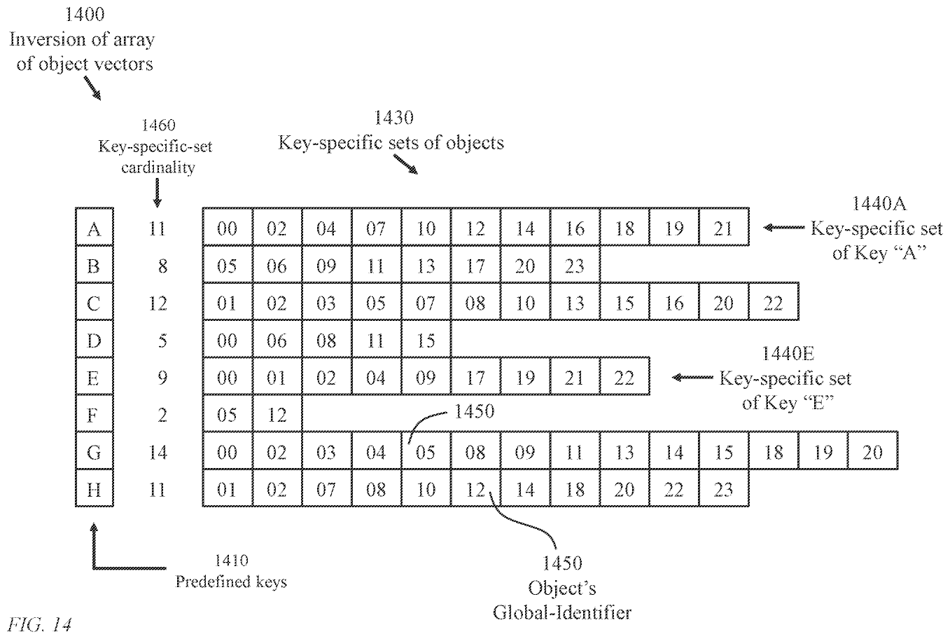

FIG. 14 illustrates inversion 1400 of the sorted array 1300 of FIG. 13 in the form of a plurality 1430 key-specific sets of objects; each key-specific set 1440 corresponds to a predefined key of a plurality of predefined keys 1410 and includes global identifiers 1450 of objects associated with the predefined key. The cardinality 1460 of each key-specific set 1440 is determined upon completion of the inversion process. The sizes (number of keys) of the 24 objects are {4, 3, 5, 2, 3, 4, 2, 3, 4, 3, 3, 3, 3, 3, 3, 3, 2, 2, 3, 3, 4, 2, 3, 2} which add up to 72. The cardinalities of the 8 key-specific sets are {11, 8, 12, 5, 9, 2, 14, 11} which add up top 72.

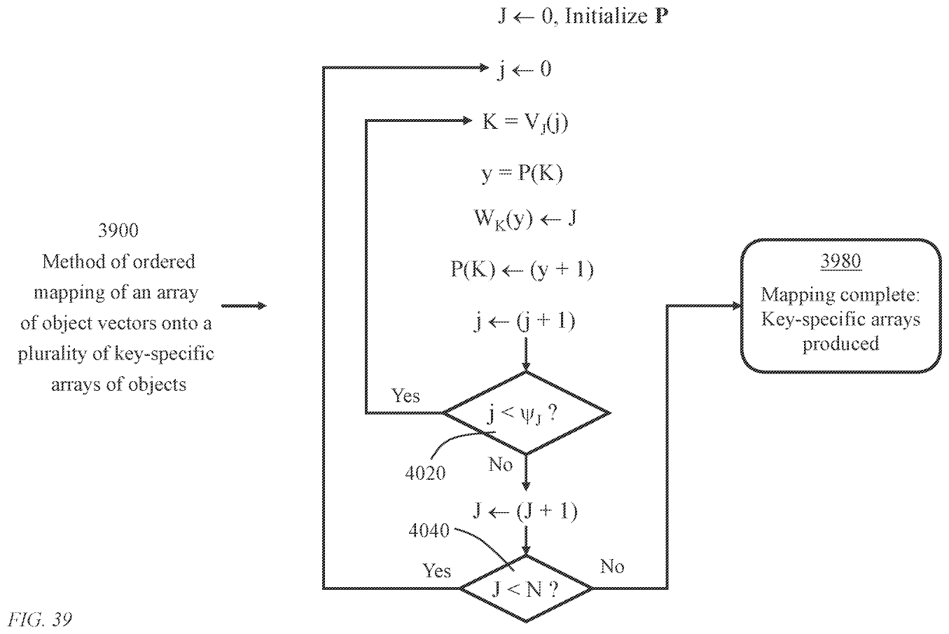

It is desirable that the entries (global object identifiers) of each key-specific array be placed in an ascending order (or a descending order) to enable fast intersection determination. This is realized with an appropriate discipline as illustrated in FIG. 39.

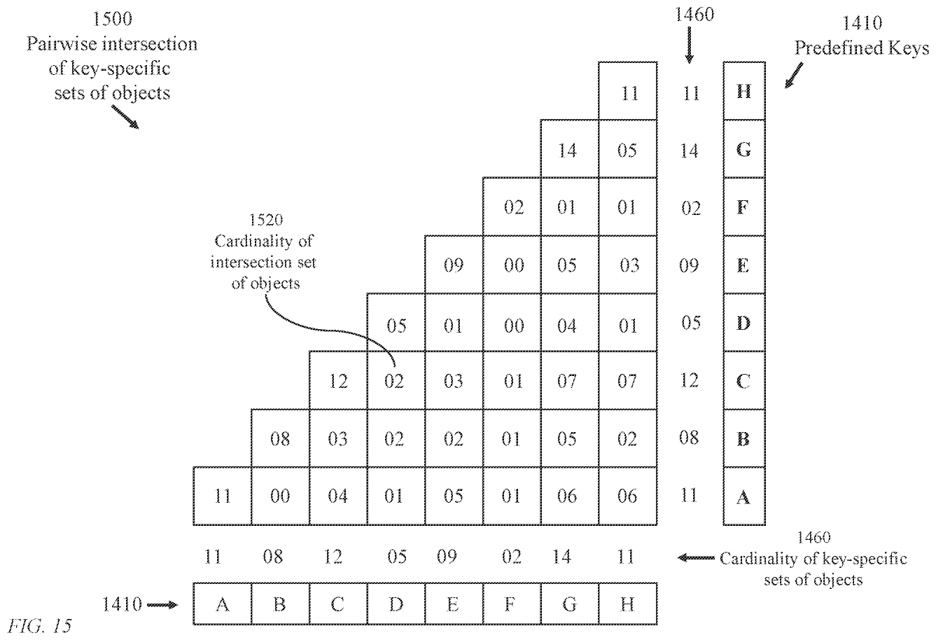

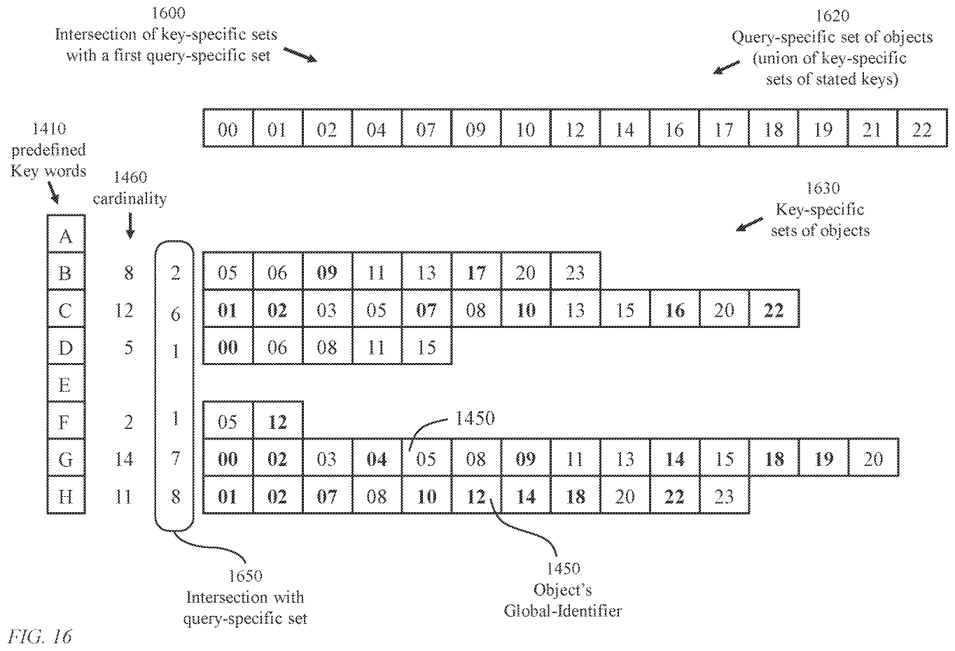

FIG. 15 illustrates a table 1500 of pairwise intersection levels of the key-specific sets of FIG. 14. The cardinality 1520 of an intersection set of each pair of key-specific sets is indicated. It is seen that the key-specific sets of keys “A” and “B” (of cardinalities 11 and 8, respectively) do not intersect, while the key-specific sets of keys “A” an “H” (of cardinalities 11 and 11), have 6 common objects. The key-specific sets of keys “C” and “E” (of cardinalities 12 and 9, respectively) have 3 objects in common, while the key-specific sets of keys “C” an “G” (of cardinalities 12 and 14, respectively) have 7 common objects. Thus, if a query specifies keys “A” and “C”, a respective query-specific set of objects would be determined and some objects of the key-specific sets of keys H and G would be considered for inclusion in a target set of objects.

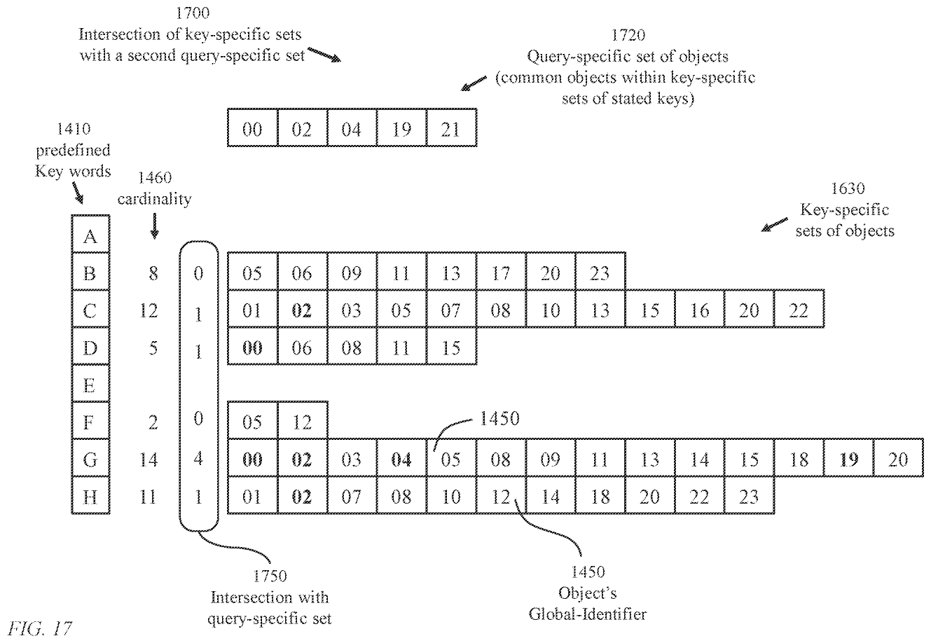

FIG. 16 illustrates intersection 1600 of individual key-specific sets with a first query-specific set 1620 of objects based on a union of key-specific sets of two keys, “A” and “E” specified in a query. Objects of each key-specific set of a plurality of key-specific sets of objects 1630, which excludes the key-specific sets of “A” and “E”, are considered for inclusion in a target set of objects. As indicated, the intersection levels of the key-specific sets of keys “B”, “C”, “D”, “F”, “G”, “H” of cardinalities 8, 12, 5, 2, 14, and 11, with the first query-set 1620 are 2, 6, 1, 1, 7, and 8. The corresponding relative intersection levels are 0.25, 0.50, 0.20, 0.5, 0.5, and 0.73. The key-specific set of “F” may be excluded due to the low cardinality. The key-specific set of “H” has the highest likelihood of being relevant to the query.

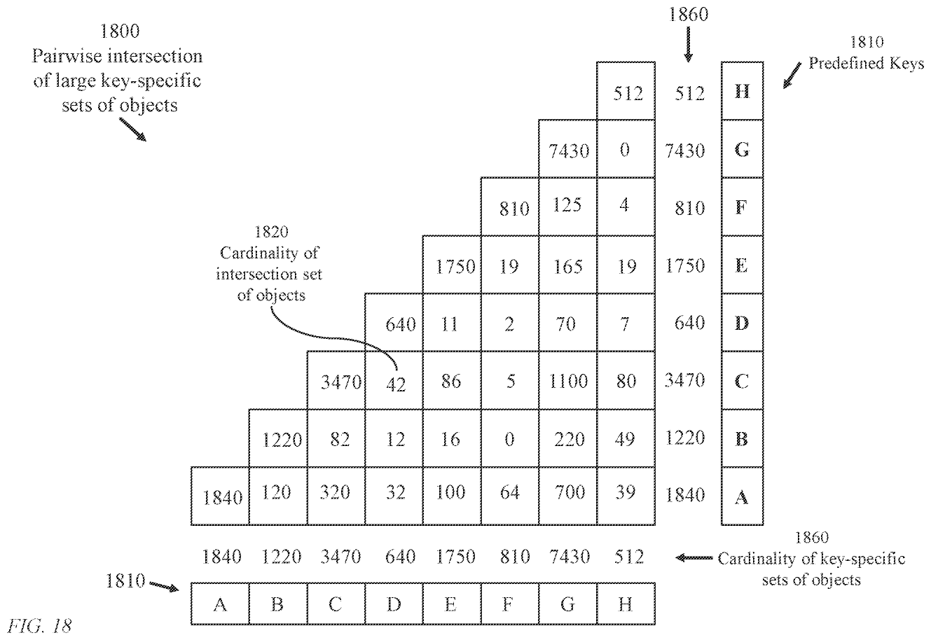

FIG. 17 illustrates intersection 1700 of individual key-specific sets with a second query-specific set 1720 of objects containing common objects of key-specific sets of two keys, “A” and “E” specified in a query. In the illustrated example, the key-specific set of “G” has the highest relative intersection level.

FIGS. 13 to 17 consider a case of a very small number of objects for ease of illustration. The disclosed query engine is intended to apply to a population of the order of one billion objects with characterizing keys taken from a set of predefined keys which may include one million keys or so. Thus, a query-specific set of objects formed as an intersection (rather than a union) of multiple key-specific sets of objects (FIG. 6) would still have significant intersection levels with numerous key-specific sets.

FIG. 18 illustrates a table 1800 pairwise intersection levels of the key-specific sets of large cardinalities where the cardinalities of the illustrated eight key-specific sets range from 512 to 7430. The number of keys is still selected to be too small for ease of illustration.

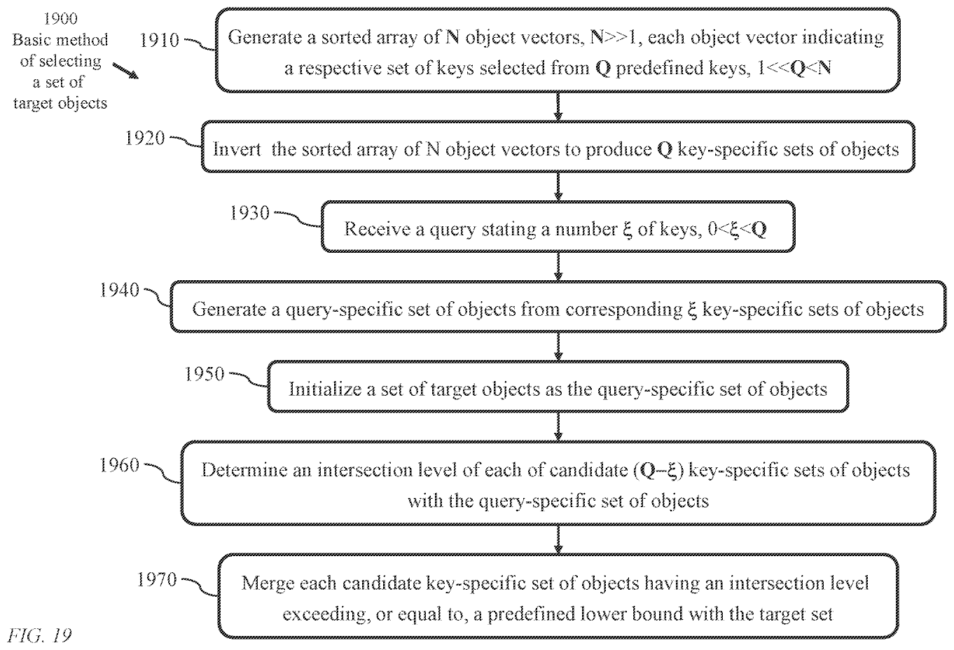

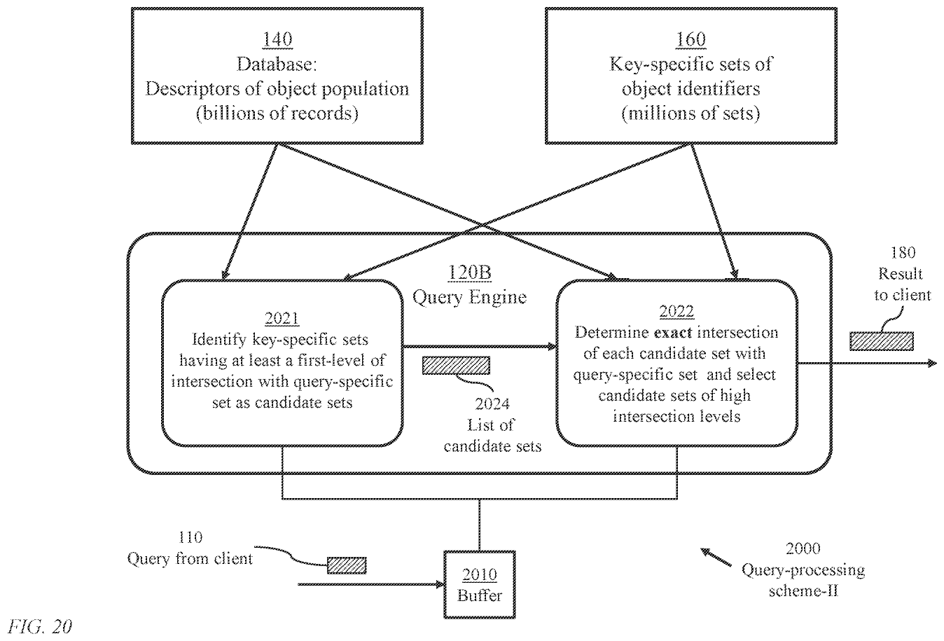

FIG. 19 illustrates a method 1900 of selecting a set of target objects in response to a query. Process 1910 generates an array of N sorted object vectors (N may be of the order of a billion) where each object vector comprises a respective number of keys from a set of predefined keys. Process 1920 inverts the array of object vectors to produce a number of key-specific sets of objects, which may be of significantly different cardinalities. The inversion maps an array of N object vectors onto Q key-specific arrays of objects. As mentioned above, it is useful to place the global object identifiers in proper order (monotonically ascending or monotonically descending) in each key-specific array to enable fast intersection determination.

Process 1930 receives a query stating a number of keys belonging to a set of predefined keys. Process 1940 generates a query-specific set of objects combining contents of ξ key-specific sets, ξ≥1, corresponding to the query-stated keys. Process 1950 initializes a set of target objects to include only the query-specific set of objects.

Process 1960 determines an intersection level of each key-specific set, excluding the key-specific sets that formed the query-specific set, with the query-specific set. Selection of candidate key-specific sets that may qualify to join the set of target objects is based on the intersection levels of key-specific sets with the query-specific set. Process 1970 selectively merges successful candidate key-specific sets with the query-specific set to form the set of target objects.

FIG. 20 illustrates a second implementation 2000 of the query-processing system of FIG. 1 using an alternate implementation 120B of query engine 120. A module 2021 produces a list 2024 of candidate key-specific sets 730 (FIG. 7) each having at least a first level of intersection with the query-specific set. Thus, module 2021 implements the coarse filtering function 720 of FIG. 7. Module 2022 determines exact intersection of each candidate set with the query-specific set and selects eligible sets 750 each having an intersection level with the query-specific set at least equal to a prescribed fraction of the candidate key-specific. Thus, module 2022 performs the process 740 of fine filtering based on exact intersection of a candidate key-specific set, rather than an estimated intersection, with the query-specific. The query engine 120B ranks the eligible sets 750 according to some merit criterion and formulates a concise output to be forwarded to the client that initiated the query. A buffer 2010 holds contents of a query.

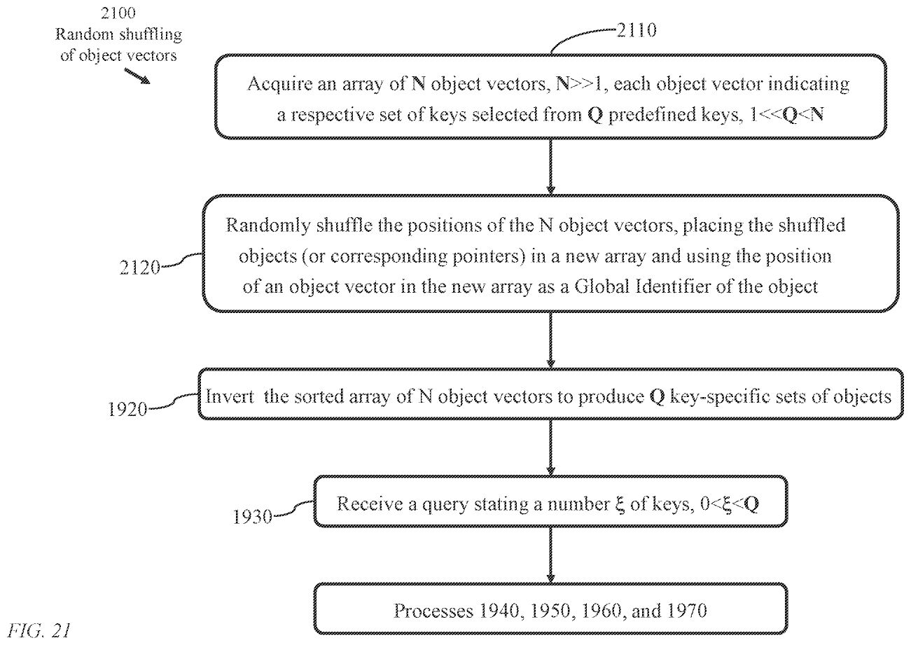

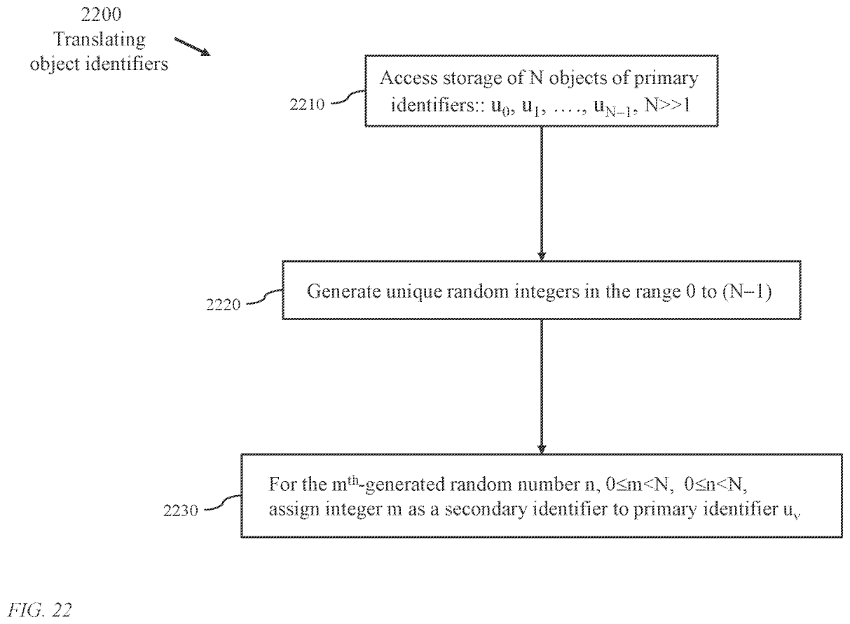

FIG. 21 illustrates details 2100 of process 1910 of generating an array of sorted object vectors. Process 2110 acquires an array of N object vectors (N may be of the order of a billion) where each object vector comprises a respective number of keys from a set of predefined keys. Process 2120 randomly shuffles the N objects to produce a sorted array of object vectors and supplies the sorted array to process 1920.

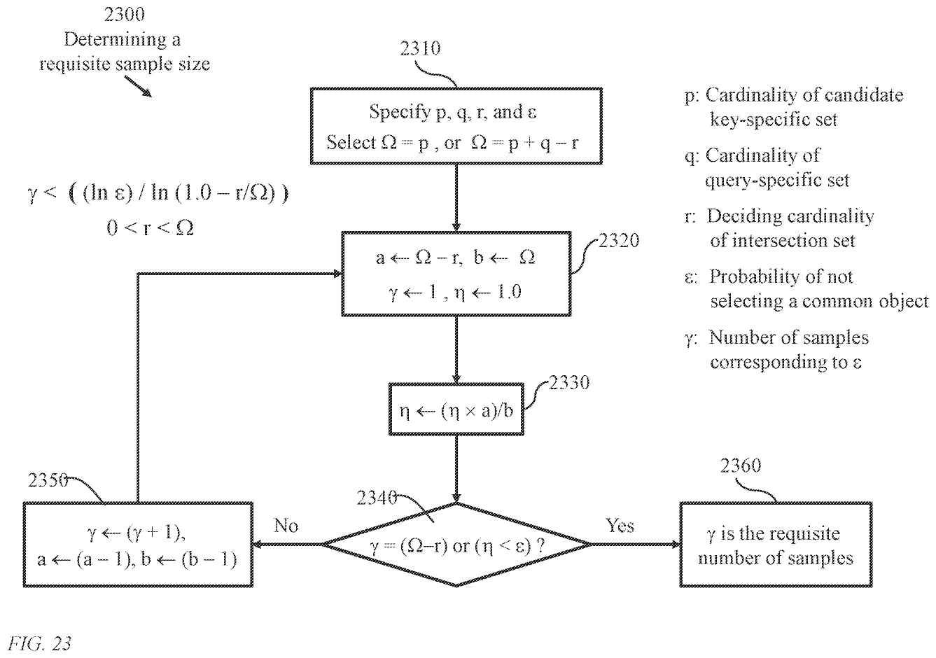

FIG. 22 illustrates details 2200 of process 2120 of object-identifier translation. Process 2210 accesses a storage 140 of the N objects 210 identified as u₀, u₁, . . . , u_{N-1} and indexed as 0 to (N−1). Process 2220 generates unique random integers in the range 0 to (N−1). Let v, 0≤v<N, be the m^{th}-generated random number, 0≤m<N. The number m is hereinafter considered the rank of the object of index v. Thus, each object of the plurality of object is assigned a rank (process 2230). The rank of an object is conveniently considered a translated identifier (a secondary identifier) of the object.

FIG. 23 illustrates a method 2300 of determining a critical sample size for fast estimation of set-intersection levels to filter out key-specific sets of weak relevance to the requirement of a query.

Step 2310 specifies the cardinalities, denoted p and q, of a key-specific set and a query-specific set, respectively, as well as a minimum relative level of intersection. The relative level of intersection may be defined as the ratio of the cardinality, r, of the intersection set to the cardinality p of the key-specific set or as the ratio r to the union (p+q−r). To determine the intersection, the method randomly selects an object of the key-specific set then determines whether the object also belongs to the query-specific set. A randomly selected object is never encountered again thanks to the initial process of randomly shuffling the array of object vectors then ordered mapping onto the key-specific sets which enables sequential selection that is equivalent to random selection without replacement.

Step 2320 initializes term “b” representing a current number of unexamined objects, term “a” representing the subset of “b” that does not belong to the intersection set, the sample count γ, and the current estimation, η, of the probability of no intersection. Naturally, the initial value of η is 1.0.

Step 2330 determines a current value of η. Step 2340 terminates the computation if the value of η is less than the specified ε probability upper bound ε (for example, 0.01) or if the number of examined objects has reached the hypothesized number of single-set objects (a single-set object is an object that belongs to only one set). Step 2350 randomly selects a new sample and updates terms to account for reduced sample space due to non-replacement (as described above, sequential inspection of shuffled objects is equivalent to random selection).

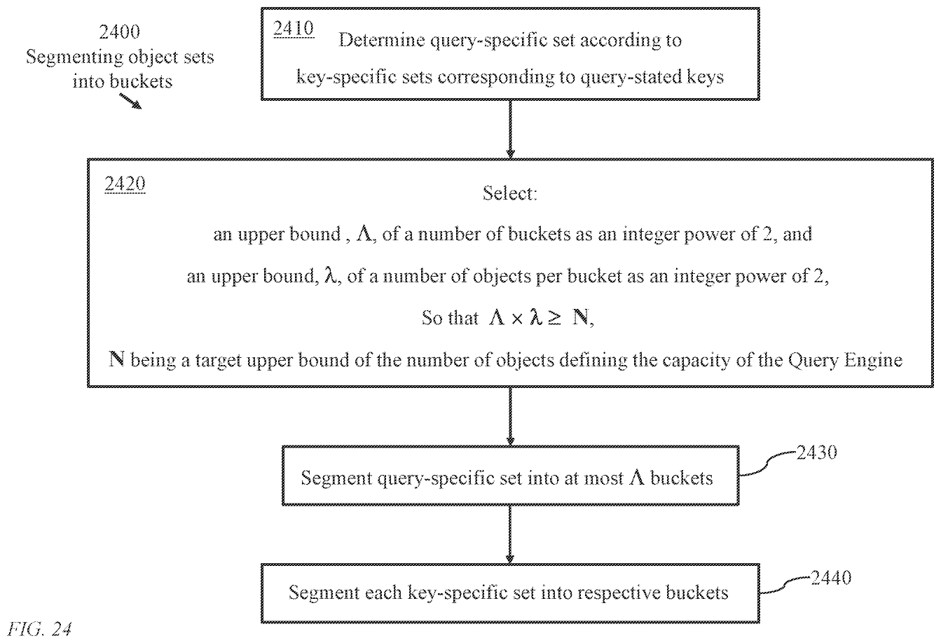

FIG. 24 illustrates processes 2400 of segmenting object sets, including a master set and the Q key-specific sets, into a specified upper bound, Λ, of a number of buckets, indexed as 0 to (Λ−1), where a bucket of index J, 0≤J<Λ, contains objects within a respective range for each object set. Process 2410 determines a master set according to key-specific sets corresponding to keys stated in a query as illustrated in FIGS. 3 to 6.

Process 2420 selects the upper bound Λ as an integer power of 2 and selects an upper bound, λ, of a number of objects within a bucket as a power of 2. The selection of Λ and λ is based on a target upper bound of a number N of objects that the query engine is expected to handle. Generally, Λ×λ≥N. In the case where Λ×λ>N, some buckets may be empty. Also, since each of the Q key-specific sets contains a number of objects that is generally less than N, with some key-specific sets each containing a number of objects that is substantially smaller than N, several bucket of a key-specific set may be empty.

For example, with N=1,000,000,000 objects and λ=2¹⁶=65536, the N objects would be segmented into at most ┌N/λ┐=15259 buckets (indexed as 0 to 15258). With Λ selected to be 214=16384, and the N objects are ranked as 0 to (N−1), buckets of indices 15259 to 16383 (a total of 1125 buckets) would be empty until the number of objects increases.

Process 2430 segments the master set into at most Λ buckets. Process 2440 segments each key-specific set into respective buckets. The buckets of the master set may then be compared with counterpart buckets of each of the Q key-specific sets. A bucket of index J of the master set is compared with a bucket of the same index J of a key-specific set under consideration, 0≤J<A.

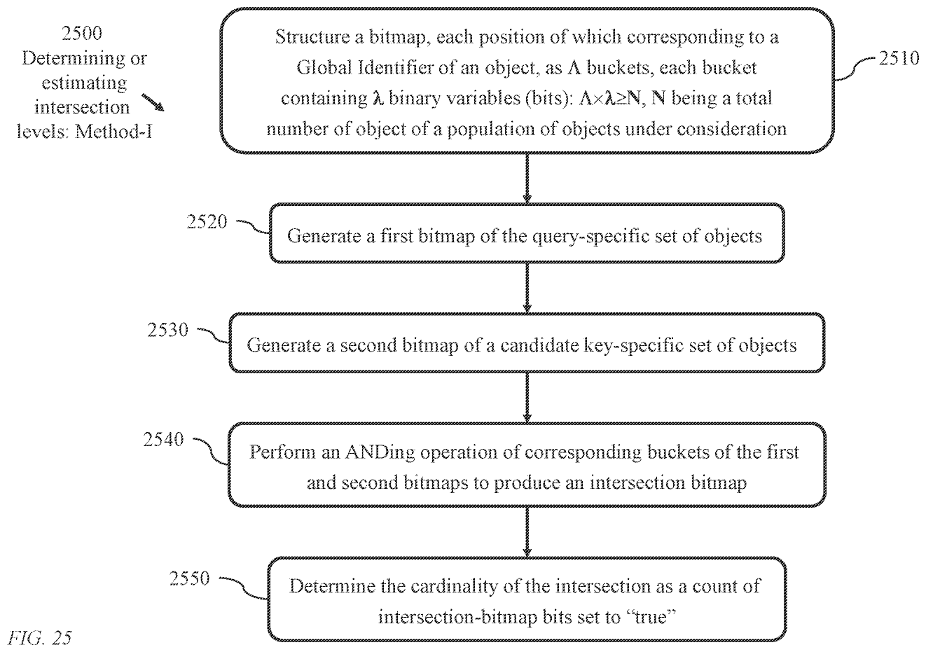

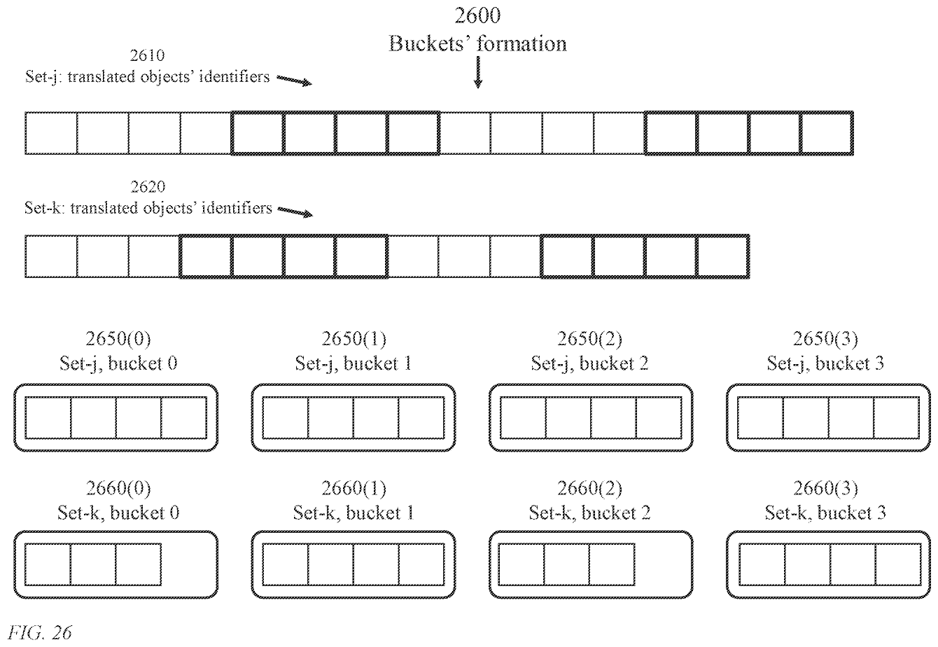

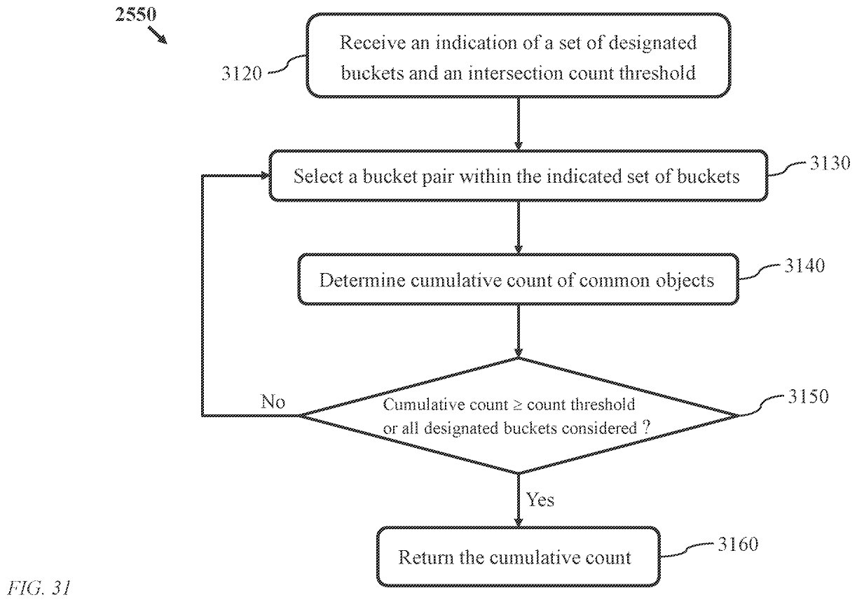

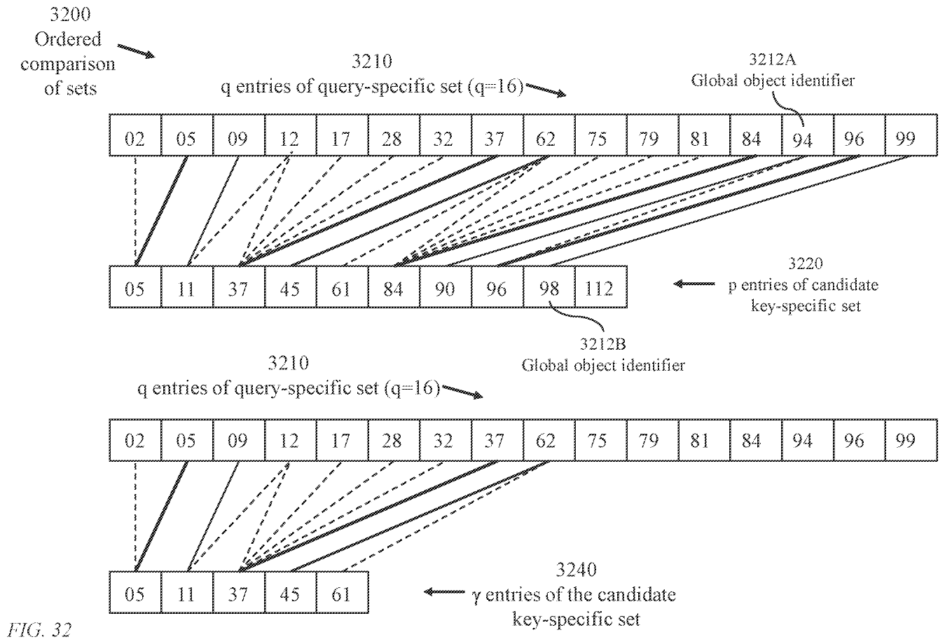

FIG. 25 illustrates a first method 2500 of determining set intersection. Process 2510 structures a bitmap where the position of a bit corresponds to a global identifier of an object. Process 2520 generates a first bitmap of a query-specific set of objects. Process 2530 generates a second bitmap of a candidate key-specific set of objects. Process 2540 performs a logical AND operation of corresponding buckets of the first and second bitmaps. Process 2550 determines cardinality of an intersection set (to be further detailed in FIG. 31).

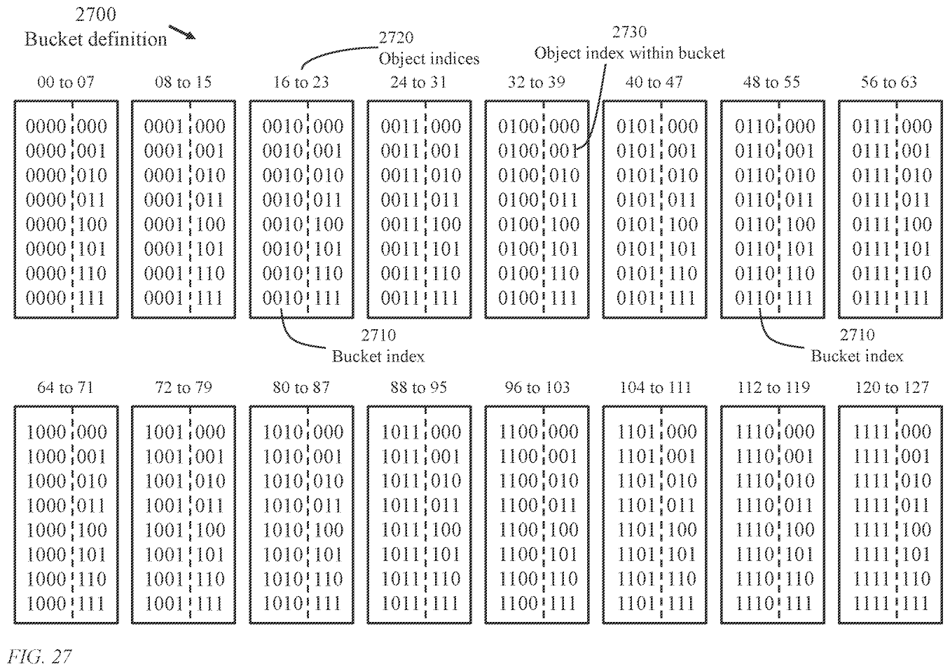

FIG. 26 illustrates an exemplary scheme 2600 of segmenting sets of objects into buckets applied to a first set 2610 of translated object identifiers and a second set 2620 of translated object identifiers. The first set 2610 is segmented into four buckets 2650, individually identified as 2650(0) to 2650(3). The second set 2620 is segmented into four buckets 2660, individually identified as 2660(0) to 2660(3).

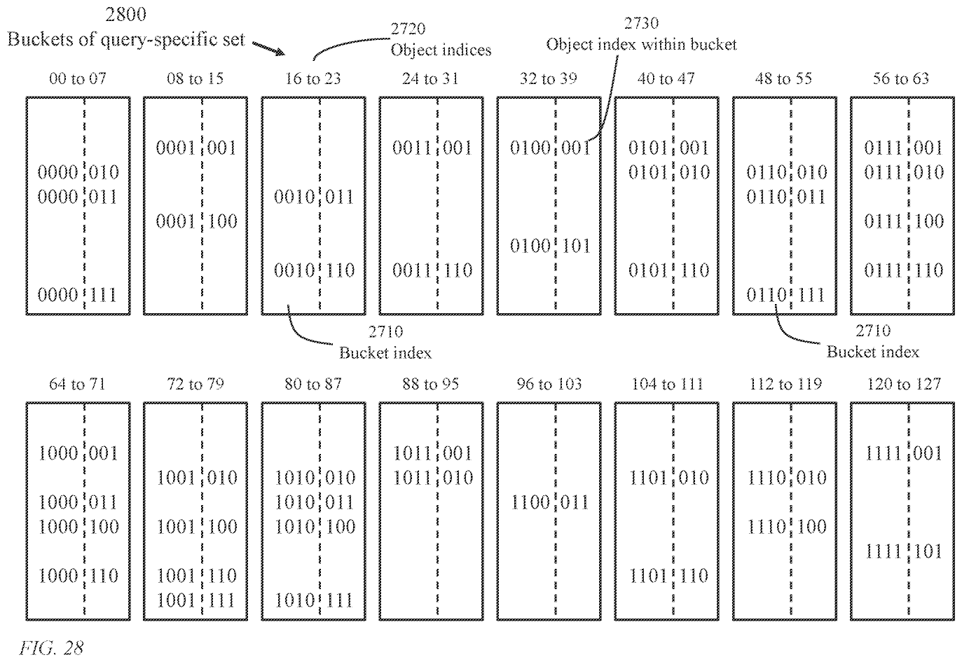

FIG. 27 illustrates an implementation 2700 of process 2420 (FIG. 24) for selecting a number of buckets and contents per bucket. Consider a relatively small number N of objects of 90, for example. To select both the upper bound λ of the maximum number of objects per bucket and the upper bound Λ of the number of buckets to be integer powers of 2, the number N is increased to N*, the nearest integer power of 2, which is 2⁷. Selecting λ to be 8, then the upper bound Λ of the number of buckets is 2⁴. Since the current size N is only 90, which would occupy buckets of indices 0 to 11, the four buckets of indices 12 to 15 will be empty until N increases to more than 96. Thus, an object of a translated identifier (secondary identifier) k, 0≤k<N, would be assigned to position y (1730) of a bucket of an index x, where x is the most significant four bits of the binary representation of k and y is the least significant three bits of the binary representation of k. Thus, all objects of translated identifiers 2720 [0 to 7] are assigned to a bucket of index 0 (1710, “0000”) and all objects of translated identifiers 2720 [80 to 87] are assigned to a bucket of index 10 (1710, “1010”).

The illustrated buckets of FIG. 28 and FIG. 29 correspond to a case where N=128, Λ=16, and λ=8. hence any of the 16 buckets may contain objects.

FIG. 28 illustrates buckets of a master set of objects of translated identifiers {2, 3, 7, 9, 12, 19, 22, 25, 30, 33, 37, 41, 42, 46, 50, 51, 55, 57, 58, 60, 62, 65, 67, 68, 70, 74, 76, 78, 79, 82, 83, 84, 87, 89, 90, 99, 106, 110, 114, 116, 121, 125}.

FIG. 29 illustrates buckets of a key-specific set under consideration containing translated identifiers {6, 12, 17, 25, 28, 33, 43, 55, 70, 75, 82, 89, 97, 110, 120, 126}.

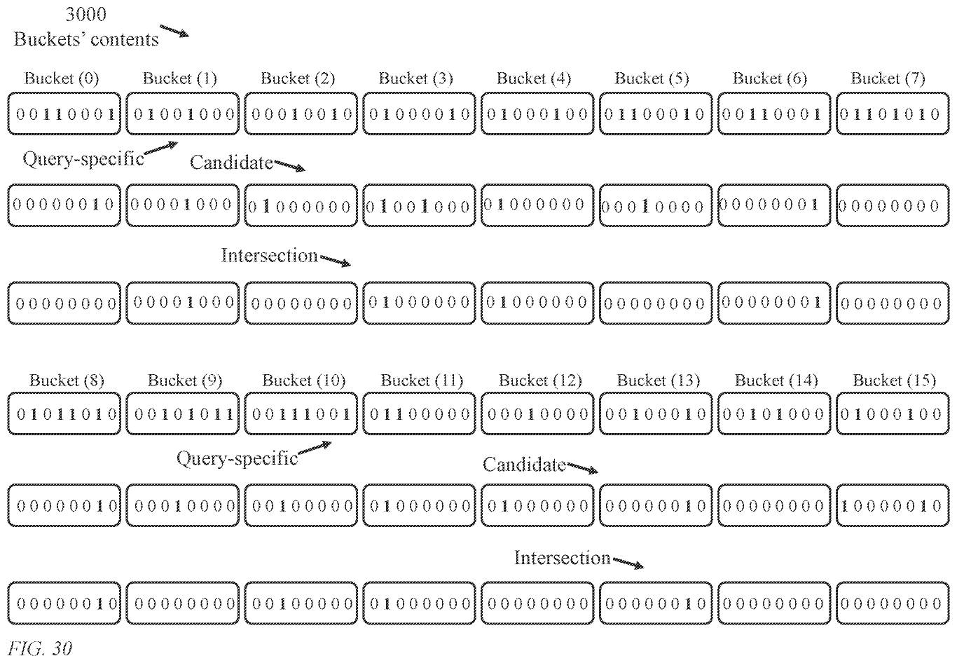

FIG. 30 illustrates buckets' content 3000. Bitmaps 3020 of the master set of FIG. 28 and bit maps 3040 of the key-specific set of FIG. 29 are illustrated where each object is represented as logical “1” at a respective position in a respective bucket. A logical “0” in a bit map indicates absence of a respective object. To determine a level of intersection of the key-specific set under consideration and the master set, the respective bit maps are ANDed, to produce intersection bitmaps 3060, starting with bucket-0 of each set, and a count of bits set to logical “1” of the ANDed result determines the level of intersection. With a large number of buckets, 65536, for example, counting the number of common objects, called credit as indicated in FIG. 35, starting with bucket-0, may be terminated when a target credit is reached. This early termination may be applied in the coarse filtering process 720 (FIG. 7).

FIG. 31 illustrates details process 2550 of determining intersection of two sets for use in the method of FIG. 25. Process 3120 receives an indication of a set of designated buckets and an intersection count threshold. Process 3130 selects a bucket pair. Process 3140 determines cumulative count of common objects in the two buckets. Process 3150 decides continuing or terminating counting Process 3160 reports the count of common objects.

FIG. 32 illustrates ordered comparison 3200 of sets of objects to determine intersection level. An exemplary query-specific array 3210 of objects contains 16 objects of global object identifiers 3212A of {02, 05, . . . , 96, 99}. An exemplary key-specific array 3220 of objects contains 10 object identifiers 3212B of {05, 11, . . . , 98, 112}. Because of the ordered mapping of the array of object vectors onto the key-specific arrays (key-specific sets) of objects described above, the global identifiers in query-specific set and the key-specific set are sequentially placed in an ascending order.

To identify common objects, a pointer to the query-specific is initialized to 0 and a pointer to the key-specific set is initialized to 0. Upon comparing entries according to the current values of the pointers, the entry, 0.5, in array 1220 is larger than the entry, 02, of array 1210. Thus, the pointer of array 1210 is advanced one position from 0 to 1. Now the entry of array 1220, 05, equals the entry of array 1210. Because of the equality, each of the two pointers is advanced one position. The pointer to array 1210 is advanced to 2 and the pointer to array 1220 is advanced to 1. The process continues in this fashion where a pointer yielding a lower value in a comparison is advanced one step while both pointers yielding equality are advanced one position each. Consequently, the total number of comparisons is less than the sum of the cardinalities of the two arrays (the two sets).

The exhaustive search yields 4 common objects of global identifiers {05, 37, 84, and 96}. If the number of samples is limited to five (γ=5), for example, a subset 3240 of the key-specific set 3220 is used and the number of common objects is 2. As discussed above, the use of sequentially listed global object identifiers is equivalent to random selection because of the initial random shuffling and ordered mapping.

The cardinalities of the query-specific set and the key-specific set are selected to be very small for each of illustration. With a number, N, of objects of the order of one billion and a number, Q, of key specific set of the order of one million, the cardinalities of the query-specific set and the key-specific set may be 5000 and 1000, respectively. Computation of the intersection of a query0specific set for a query specifying 8 keys, for example, would require determining intersection of the query-specific set with (Q−8) key specific sets with a likelihood that very few key-specific arrays (key-specific sets) would have significant numbers of objects in common with the query-specific sets. Thus, in a first round, (Q−8) intersections would be performed, each with a number of samples of 100 or so (to be determined rigorously), and in a second round, only key-specific arrays of estimated significant intersection would be considered.

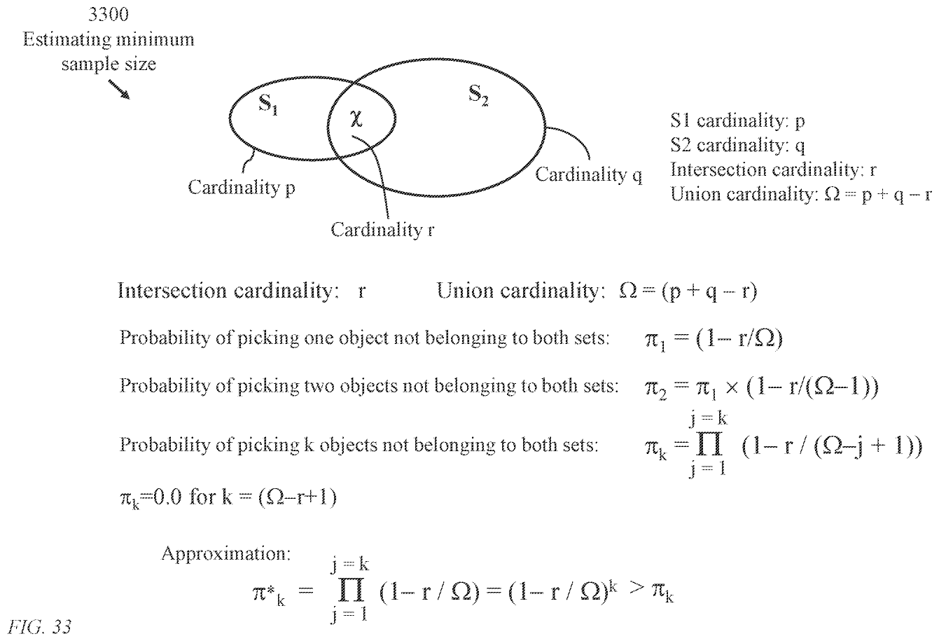

FIG. 33 illustrates a method 3300 of estimating a critical sample size. Let S be a key-specific set (key-specific array) 220, FIG. 2, under consideration and S* be the query-specific set (query-specific array) of objects (FIG. 5 or FIG. 6). The cardinality |S| of set S is denoted p and the cardinality |S*| of query-specific set (query-specific array) S* is denoted q. The cardinality of the intersection χ is denoted r.

The probability that an unbiased observer randomly picks an object belonging to the union of S and S* that also belongs to the intersection χ is the Jaccard coefficient r/(p+q−r).

If the observer picks a first object (any object) within S then randomly picks an object in S*, referenced as a “second object”, the probability of the second object being the first object, i.e., the probability that the second object is within the intersection χ, is r/p.

Sampling the union S∪S* is herein referenced as the first sampling method while sampling set S (or generally, the smaller of two sets) is referenced as the second sampling method.

As illustrated in FIG. 30, corresponding buckets of the master set and the set under consideration are ANDed sequentially, i.e., bits representing presence (“1”) or otherwise (“0”) of an object in a respective set are inspected sequentially. The sequential inspection is equivalent to random sampling because the objects 212 of the universe 210 of objects are randomly shuffled as illustrated in FIG. 11.

Thus, the probability that a randomly picked object (a sample) from union S∪S* (first sampling method) belongs to the intersection χ is r/Ω. The probability that a randomly picked object (a sample) from set S only (second sampling method) belongs to the intersection χ is r/p. The ANDing process depicted in FIG. 30 is implicitly an efficient implementation of the second sampling method.

With the first sampling method, the probability of a sample of a sequence of successive samples being outside the intersection χ is determined as:

$${π}_{1} = ( 1 - r \text{/} Ω ) for the first sample ;$$

$${π}_{2} = {π}_{1} \times ( 1 - r \text{/} ( Ω - 1 ) ) for the second sample ;$$

$$…$$

$${π}_{k} = {π}_{( k - 1 )} \times ( 1 - r \text{/} ( Ω - j + 1 ) ) = {\prod }_{j} ( 1 - r \text{/} ( Ω - j + 1 ) , \\ 1 \leq j \leq k , k < Ω , for the {k}^{th} sample .$$

πₖ is the probability that k successive samples are all outside the intersection χ, which is the probability that at least one of the k samples is within the intersection. Selecting k to yield a value of πₖ that is negligibly small (0.01, for example), then k defines a critical sample size after which the sampling process is terminated if a sample (an object) that does not belong to the intersection χ is not found.

If it is conjectured that the number k of successive samples that yields a prescribed high probability (0.99, for example) of finding at least one sample belonging to the intersection χ is much smaller the cardinality |Ω| of the union S∪S*, then πₖ may be approximated as:

πₖ*=(1−r/Ω)^{k}>πₖ.

Thus, with ρ denoting the ratio r/Ω, i.e., a specified relative intersection lower bound, the probability η that none of k randomly selected objects of the key-specific array is found in the query-specific array is approximated as (1.0−ρ)^{k}. Thus, the number k corresponding to a probability of finding at least one common object in the key-specific array and the query-specific array is determined as:

k>logₑ(η)/logₑ(1.0−ρ).

The critical value of k, denoted γ* is then ┌logₑ(η)/logₑ(1.0−ρ)┐.

For η=0.01 and ρ=0.2, γ*=21.

With the second sampling method, the probability of a sample of a sequence of successive samples being outside the intersection χ is determined as:

$${π}_{1} = ( 1 - r \text{/} p ) for the first sample ;$$

$${π}_{2} = {π}_{1} \times ( 1 - r \text{/} ( p - 1 ) ) for the second sample ;$$

$$…$$

$${π}_{k} = {π}_{( k - 1 )} \times ( 1 - r \text{/} ( p - j + 1 ) ) = {\prod }_{j} ( 1 - r \text{/} ( p - j + 1 ) ) , \\ 1 \leq j \leq k , k < p , for the {k}^{th} sample .$$

As in the case of the first sampling method, πₖ is the probability that k successive samples are all outside the intersection χ, which is the probability that at least one of the k samples is within the intersection. A number k that yields a value of πₖ that is negligibly small defines a critical sample size after which the sampling process is terminated if a sample (an object) that does not belong to the intersection χ is not found.

If it is conjectured that the number k of successive samples that yields a prescribed high probability (0.99, for example) of finding at least one sample belonging to the intersection χ is much smaller the cardinality |Ω| of the union S∪S*, then πₖ may be approximated as:

πₖ*=(1−r/p)^{k}>πₖ.

With p=50000, r=10000, Ω=200000, for example:

the value of k (the critical sample size) that yields (1−r/Ω)^{k}=0.01 is k=┌−2/log 0.95┐=90; and the value of k (the critical sample size) that yields (1−r/p)^{k}=0.01 is k=┌−2/log 0.95┐=21.

Thus, applying the second sampling method (FIG. 30) appreciably reduces the computation effort.

With ρ denoting the ratio r/p, and with (r/p)<<1, the critical value of k, may also be approximated as ┌logₑ(η)/logₑ(1.0−ρ)┐. Otherwise, the precise critical number of samples is determined (FIG. 23).

With γ samples, the expected value of the number of common objects in the key-specific array and query-specific array is (γ×ρ), which is generally a real number. The actual ratio of the count of common objects to the number of samples may be used to determine whether or not the key-specific set under consideration is relevant to a current query. According to an embodiment, a threshold of relative intersection is determined and the key-specific array under consideration is considered irrelevant to the query if the actual ratio is below the threshold. Otherwise, the key-specific array is treated as a candidate for inclusion in a target set of objects.

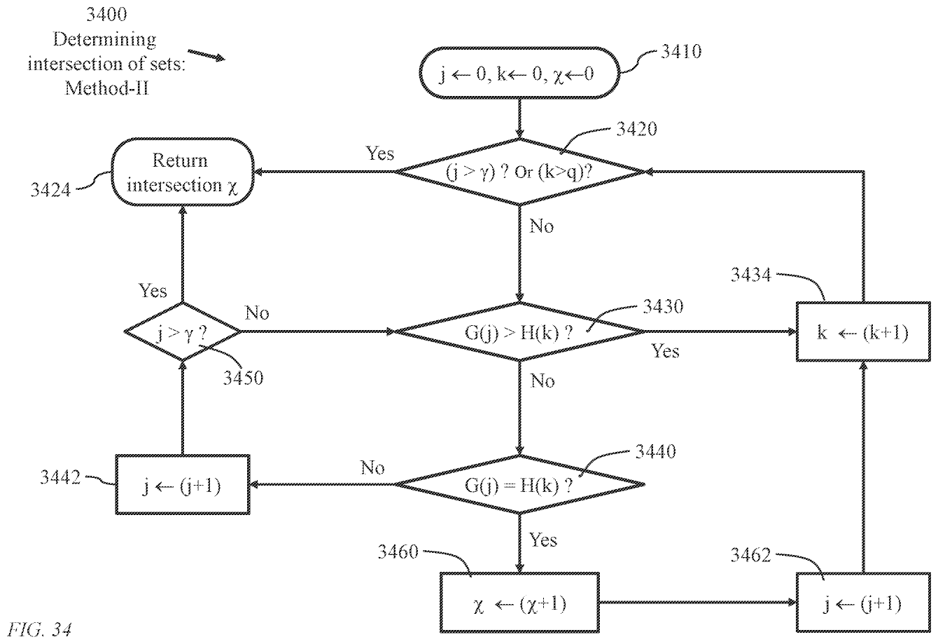

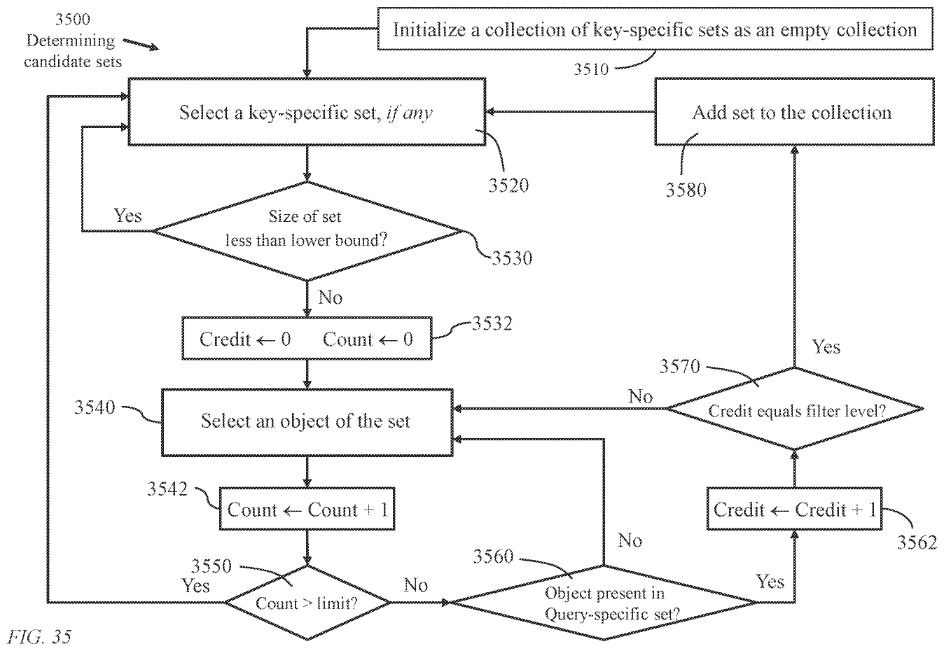

FIG. 34 illustrates a second method 3400 of determining intersection level of a key-specific set and a query-specific set based on γ samples. Ordered objects of a key-specific set are placed in an array G* and ordered objects of a query-specific set are placed in an array H* as described above (FIG. 14, FIG. 16). An index j of array G* and an index k of array H* are initialized to equal 0. A count χ of common objects is initialized as 0 (step 3410).

Process 3420 determines whether the procedure of determining the intersection is complete; this is ascertained if index j is less than a predefined sample size γ and index k is not greater than the cardinality, q, of the query-specific set. If the procedure is complete, process 3424 reports the resulting intersection count χ; otherwise, step 2430 compares a global object identifier G*(j) of the key-specific set to a global object identifier H*(k) of the query-specific set to branch to either step 3434 or step 3440.

Step 3434 increases index k then revisits step 3420. Step 3440 determines equality or otherwise of G*(j) and H*(k) and branches to either step 3442 or step 3460.

Step 3442 increases index j then step 3450 compares index j to the predefined sample size γ to branch to either step 3430 or step 3424 (completion). Step 3460 increases the count χ and proceeds to step 3462 to increase index j, step 3434 to increase index k, then step 3420.

FIG. 35 illustrates a method 3500 of determining candidate key-specific sets of objects (730, FIG. 7). A collection of candidate sets is initialized as an empty collection (process 3510). Process 3520 considers a key-specific set (process 3520) from the Q key-specific sets 220 maintained in storage 160. The process terminates when each of the Q key-specific sets is considered. The size (cardinality) of each key-specific set is known. If the size of a key-specific set under consideration is less than a predetermined size lower bound, process 3530 revisits process 3520 to consider another key-specific set, if any. Otherwise process 3532 initializes a sampling count as zero and an intersection credit as zero. Process 3540 selects an object at random from the set under consideration and process 3542 increase the sampling count. If the count has already exceeded a predetermined sampling limit, process 3550 revisits process 3520 to consider another key-specific set, if any. Otherwise, process 3560 determines whether the object selected in process 3540 is present in the master set. If the object is not found in the master set, process 3560 revisits process 3540 to randomly select another object. Otherwise, process 3562 increases the intersection credit. Process 3570 determines whether the accumulated credit is sufficient to promote the set under consideration to a candidate set to be further subjected to the fine filtering process 740 (FIG. 7). If the accumulated credit is not sufficient, process 3540 is revisited to randomly select another object. Otherwise, if the credit is sufficient, process 3580 adds the set under consideration to the collection of candidate sets. When all of the Q key-specific sets are considered, the outcome is a collection 730 of Θ candidate sets to be further subjected to more stringent filtering conditions in process 740.

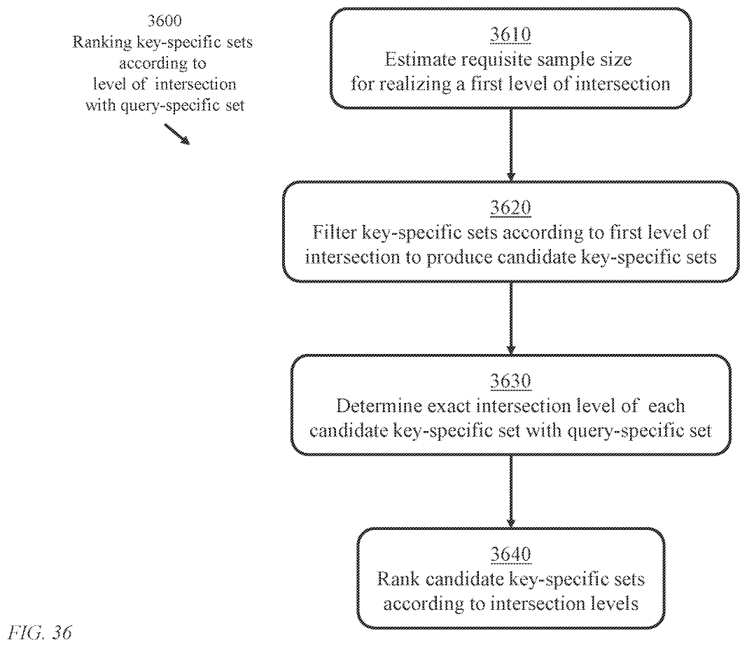

FIG. 36 illustrates an implementation 3600, in accordance with an embodiment of the present invention, of the coarse filtering process 720 and the fine filtering process 740 of FIG. 7 based on use of the bitmaps of the master set and the key-specific sets. Process 3610 estimates a requisite sample size to realize a first level of intersection of a key-specific set and the master set. The first level may be selected to be a relatively small number, 1 to 5, for example, for the process of coarse filtering to weed out key-specific sets that are deemed to have low similarity to the master set.

Process 3620 applies the method of FIG. 35 with the parameter “limit” set to equal the requisite sample size determined in process 3610 and the parameter “first level” set to an integer of at least 1.

Process 3630 determines the exact intersection of each of the Θ candidate key-specific sets, resulting from application of the method of FIG. 35, with the master set based on ANDing all corresponding bits of the key-specific set under consideration and the master set. Process 3640 ranks individual candidate key-specific sets of the collection of Θ candidate sets according to respective levels of intersection with the master set. A concise result listing key-specific sets of highest levels intersection together with other insight content are communicated to the client initiating the query.

As illustrated in FIG. 13 and FIG. 14, the exemplary randomly shuffled array 1300 of 24 object vectors is inverted into 8 key-specific arrays of objects. Each object vector comprises a respective number of characterizing keys selected from a predefined set of keys.

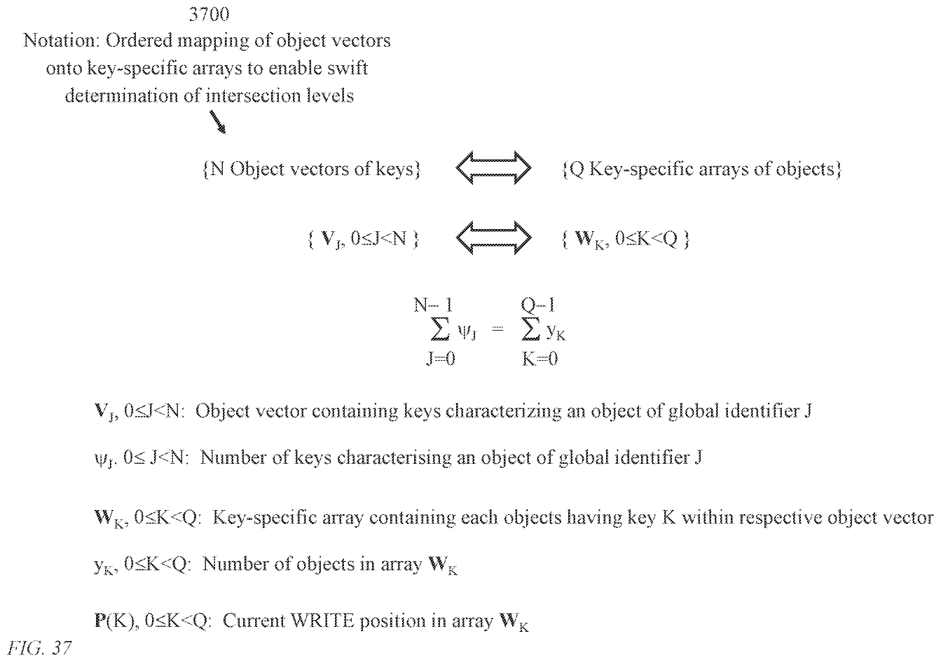

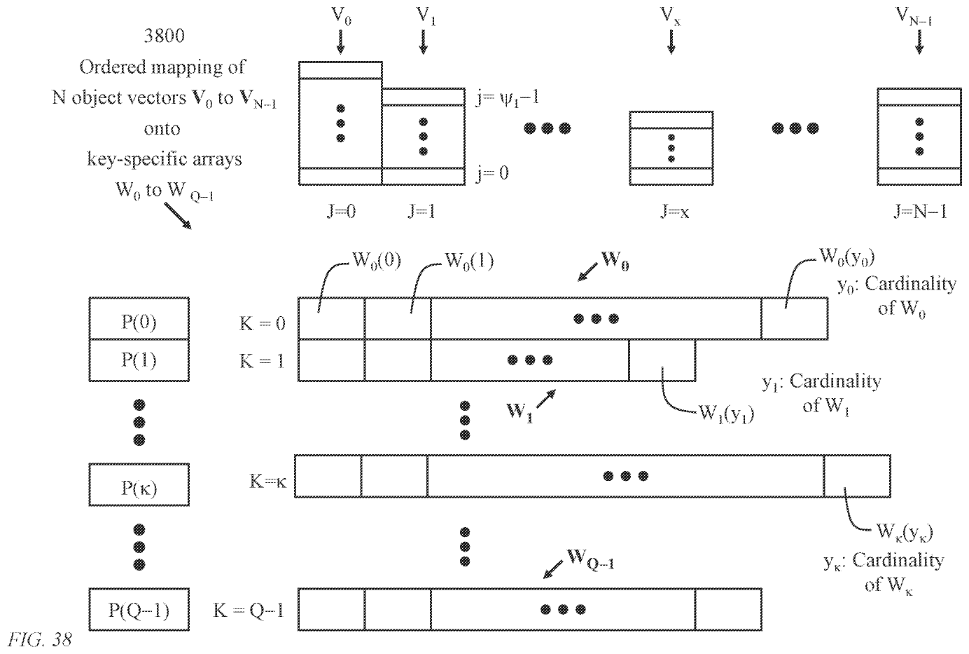

FIG. 37 defines the notation 3700 used in FIGS. 38 and 39 which illustrate an inversion process which ensures ordered mapping of a plurality of object vectors of keys onto a plurality of key-specific arrays of objects to enable swift determination of intersection levels. To illustrate the inversion process for an arbitrary number, N, of objects, the notations below are used.
(a) V_{J}, 0≤J<N, denotes an object vector containing keys (key words) characterizing an object of global identifier J.
(b) ψ_{J}, 0≤J<N, denotes a number of keys characterizing the object of global identifier J. The number of key-specific arrays is generally expected to be substantially larger than the size of any of the object vectors.
(c) W_{K}, 0≤K<Q, denotes a key-specific array containing objects each of which having an object vector including key K. Q is the total number of keys used in the array of object vectors; in other words, Q is the cardinality of the union of the N sets of keys characterizing the plurality of objects under consideration. The plurality of predefined keys may include a larger number of keys.
(d) y_{K}, 0≤K<Q, denotes the number of objects in array W_{K}.
(e) P(K), 0≤K<Q, denotes a current WRITE position for array W_{K}; P(K) is initialized as 0.

The inversion process basically restructures the N object vectors {Vⱼ, 0≤J<N} of keys into Q key-specific arrays {W_{K}, 0≤K<Q} of global object identifiers. Naturally, the summation of the N values of ψ_{J}, equals the summation of the Q values of Y_{K}.

FIG. 38 illustrates data organization 3800 for ordered mapping of the N object vectors of keys onto the Q key-specific arrays of objects. The object vectors are denoted V₀, V₁, . . . , V_{N-1}. The Q key-specific arrays of objects are denoted W₀, W₁, . . . , W_{Q-1}.

FIG. 39 illustrates a method 3900 for implementing the ordered mapping of FIG. 38. Starting with the object vector V₀, the individual keys of V₀(0) to V₀(ψ₀−1) are determined and the global object identifier 0 is written in position 0 of each of the ψ₀ keys, then the WRITE position of each of the ψ₀ keys is advanced. The process is repeated with subsequent object vectors V₁ to V_{N-1}, which are strictly selected sequentially in steps of 1. This discipline ensures that the global object identifiers placed in any key-specific array are of ascending values. The process is complete (reference 3980) when all of the N objects have been considered.

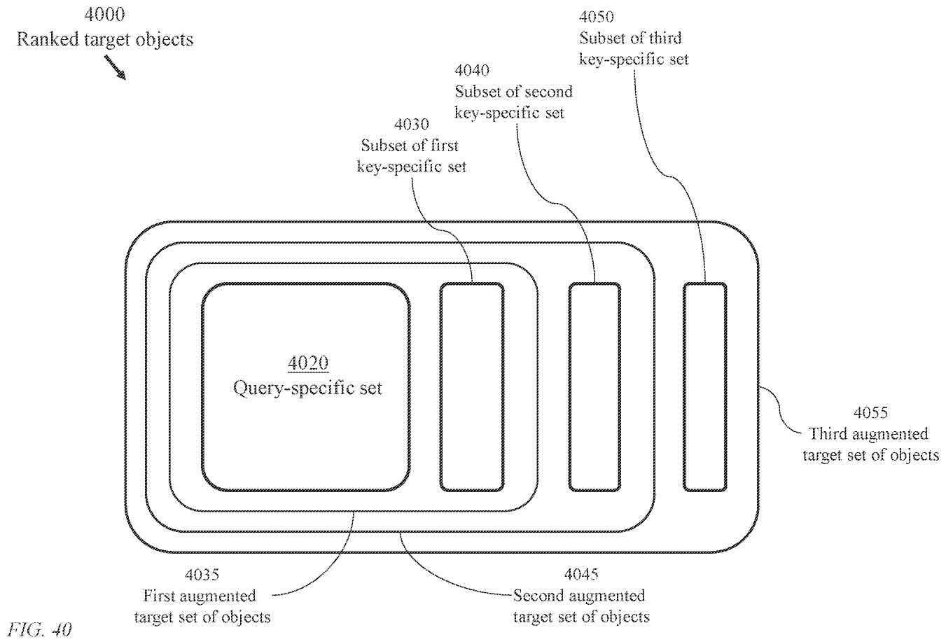

FIG. 40 illustrates ranking 4000 of target objects. The query-specific set 4020 includes objects of object vectors each of which including at least one of the keys stated in a query. Hence, the query-specific set 4020 is the kernel of the sought set of target objects. Upon determining levels of intersection of candidate key-specific sets with the query-specific set, the candidate key-specific sets are ranked according to the levels of intersection. FIG. 40 illustrates a case where only the highest three ranking key-specific sets are considered for merging with the kernel.

Subset 4030 of a first key-specific set of highest intersection with the query-specific set comprises objects not included in the query-specific set 4020. A first augmented target set 4035 is formed to comprise objects of the query-specific set 4020 and subset 4030.

Subset 4040 of the second key-specific set of second highest intersection with the query-specific set comprises objects not included in the first augmented target set 4035. A second augmented target set 4045 is formed to comprise objects of the first augmented target set 4030 and subset 4040.

Subset 4050 of the third key-specific set of third highest intersection with the query-specific set comprises objects not included in the second augmented target set 4045. A third augmented target set 4055 is formed to comprise objects of the second augmented target set 4040 and subset 4050.

The process of forming the augmented target sets of objects requires a negligible computational effort due to the ordered mapping described above.

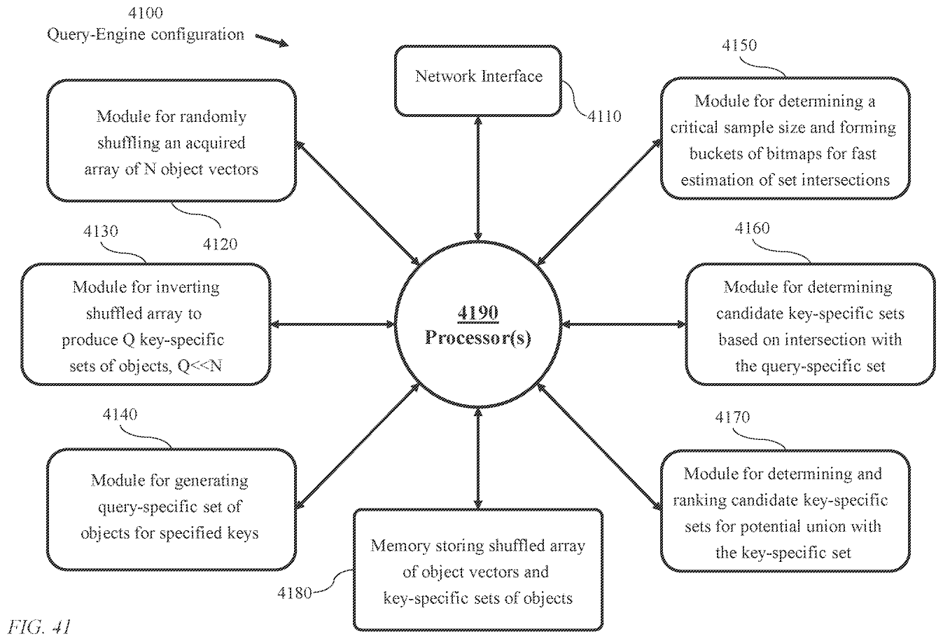

Thus, the invention provides a method (FIG. 19, FIG. 21) of selecting a target set of objects at a query engine (FIG. 41) employing at least one processor 4190 and comprises processes of acquiring 2110 an array 210 of N objects, each object associated with a respective object vector 1340 comprising a respective number of keys 1320 from a set of predefined keys, and randomly shuffling (FIG. 11, FIG. 22) the N objects to produce a sorted array of objects (FIG. 12, FIG. 13). Each object is identified according to position in the sorted array. The sorted array of objects is inverted where each object is placed in corresponding key-specific arrays based on content of a corresponding object vector (FIG. 38, FIG. 39).

Upon receiving a query stating a number of keys belonging to a set of predefined keys, a query-specific array of objects is formed to include contents of selected key-specific arrays corresponding to query-stated keys (FIGS. 3 to 6).

An intersection level of each key-specific array, excluding the selected key-specific arrays, with the query-specific array, is determined (FIG. 16, FIG. 17), and a target set of objects is formed to include the query-specific array and a subset of at least one key-specific array having an intersection level with the query-specific array exceeding a predefined lower bound (FIG. 40).

The query-specific array may be formed as a union of the selected key-specific arrays (FIG. 5) or to include only each object of the selected key-specific arrays that belongs to at least two key-specific arrays of the selected key-specific arrays (FIG. 6).

The process of determining an intersection level comprises computing a critical number of samples (FIG. 23) according to cardinality of a key-specific array and counting a first number of intersections corresponding to the critical number of samples. Where the first number, for the key-specific array, exceeds a specified intersection lower bound, counting intersection continues to determine an actual number of intersections (FIG. 7, FIG. 35). Otherwise, the key-specific array is considered irrelevant to the query and is discarded.

According to an implementation, the critical number of samples is determined as γ*=┌(logₑ η)/logₑ (1.0−ρ)┐, ρ being a ratio of the specified intersection lower bound to cardinality of a key-specific array under consideration, η being a deciding probability, selected to be less than 0.01, that none of γ* randomly selected objects of the key-specific array is found in the query-specific array.

According to another implementation, the critical number of samples is determined from a recursion (FIG. 23):

π₀=1, and

πⱼ←πⱼ₋₁×(1−r/(Ω−j+1)), j>0, π_{γ}<η,

where Ω denotes cardinality of the key-specific array under consideration and η denotes a deciding probability, selected to be less than 0.01, that none of γ randomly selected objects of the key-specific array is found in the query-specific array.

The process of ordered mapping comprises a step of selecting objects of the sorted array sequentially, then for each selected object and for each indicated key in a respective object vector, an identifier of a position of the object in the sorted array is inserted at a first free position of a respective key-specific array.

The query engine uses either of two methods for fast determination of an intersection level of a key-specific array and a query-specific array.

The first method (FIGS. 25 to 31), for fast determination of an intersection, segments the query-specific array and each key-specific array into Λ buckets, each bucket corresponding to λ objects so that Λ×λ≥N. A first bitmap of the query-specific array of objects is generated and a second bitmap of a selected key-specific array is generated. A logical AND operation of designated buckets of the first bitmap and corresponding buckets of the second bitmaps is performed and the intersection level based on the outcome of the AND operation is then determined.

The second method (FIG. 32, FIG. 34), for fast determination of an intersection, initializes a first pointer to the key-specific array to 0, initializes a second pointer to the query-specific array to 0, then recursively execute processes of:
comparing a first entry in the key-specific array corresponding to the first pointer with a second entry in the query-specific array corresponding to the second pointer;
advancing the first pointer subject to a determination that the first entry is less than the second entry;
advancing the second pointer subject to a determination that the second entry is less than the first entry; and
advancing the first pointer and the second pointer subject to a determination of equality of the first entry and the second entry.

In order to determine a target set of objects corresponding to the keys stated in the query, the query engine performs processes of FIG. 40.

FIG. 41 illustrates a configuration 4100 of a query engine. The engine comprises a processor, or generally an assembly of processors, 4190 coupled to network interface 3910, processing modules 4120, 4130, 4140, 4150, 4160, and 4170, and memory 4180.

The network interface and the processing modules may have respective hardware processors, or may dynamically share a plurality of hardware processors.

Module 4120 comprises a memory device holding software instructions which cause a respective processor to randomly shuffle an array of object vectors to produce a sorted array of object vectors where an index of an object vector in the sorted array is used as a global object identifier. Module 4130 comprises a memory device holding software instructions which cause a respective processor to invert the sorted array of object vectors to produce key-specific sets of objects. FIGS. 38-40 detail the inversion process. Module 4140 comprises a memory device holding software instructions which cause a respective processor to generate a query-specific set of objects corresponding to key-words specified in a query.

Module 4150 comprises a memory device holding software instructions which cause a respective processor to determine a critical sample size and selecting parameters of a bitmap of a set of objects. Module 4160 comprises a memory device holding software instructions which cause at least one processor to determine candidate key-specific sets of objects based on intersection with a query-specific set of objects. Module 4170 comprises a memory device holding software instructions which cause a respective processor to determine candidate key-specific sets of objects for potential union with the key-specific set, and rank the candidate key-specific set according to intersection levels. Memory device 4180 stores the sorted array of object vectors and the key-specific sets of objects.

The invention provides a query engine configured to process data organized into descriptors of a universe of objects and a plurality of key-specific set of objects, each set including objects of a common property (characteristic, trait, interests, . . . ) and derive insights based on rapidly computing an indicator of similarity of each key-specific set of objects to a model set of objects, also referenced as a “master set”.

The engine performs a coarse filtering process to eliminate key-specific sets that are unlikely to be of sufficient similarity to the master set and retain the remaining key-specific sets as candidate sets for further processing.

The engine inspects a predetermined number of successive samples of a key-specific set to determine the likelihood of significant similarity to the master set. Where the likelihood is ascertained, the engine determines exact intersection of the key-specific set with the master set based on ANDing respective bitmaps. The predetermined number of successive samples may be based on either estimation of a level of intersection of the key-specific set to the master set, or a specified confidence level and confidence interval.

Methods of the embodiments of the invention may be performed using at least one hardware processor, executing processor-executable instructions causing the at least one hardware processor to implement the processes described above. Computer executable instructions may be stored in processor-readable storage media such as floppy disks, hard disks, optical disks, Flash ROMs (read only memories), non-volatile ROM, and RAM (random access memory). A variety of processors, such as microprocessors, digital signal processors, and gate arrays, may be employed.

Systems of the embodiments of the invention may be implemented as any of a variety of suitable circuitry, such as one or more microprocessors, digital signal processors (DSPs), application-specific integrated circuits (ASICs), field programmable gate arrays (FPGAs), discrete logic, software, hardware, firmware or any combinations thereof. When modules of the systems of the embodiments of the invention are implemented partially or entirely in software, the modules contain a memory device for storing software instructions in a suitable, non-transitory computer-readable storage medium, and software instructions are executed in hardware using one or more processors to perform the methods of this disclosure.

It should be noted that methods and systems of the embodiments of the invention and data described above are not, in any sense, abstract or intangible. Instead, the data is necessarily presented in a digital form and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst due the complexity and vast numbers of intermediate results generated for processing and analysis of even quite modest amounts of data. Instead, the methods described herein are necessarily carried out by electronic computing systems having processors on electronically or magnetically stored data, with the results of the data processing and data analysis digitally stored in one or more tangible, physical, data-storage devices and media.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

1. A method of selecting a target set of objects, implemented at a query engine employing at least one processor, the method comprising:
acquiring an array of N objects, each object associated with a respective object vector comprising a respective number of keys from a set of predefined keys;
randomly shuffling the N objects to produce a sorted array of objects;
inverting the sorted array of objects with ordered mapping onto a number of key-specific arrays of objects identified as positions of said sorted array;
receiving a query stating a number of keys belonging to a set of predefined keys;
forming a query-specific array of objects including contents of selected key-specific arrays corresponding to query-stated keys;
determining an intersection level of each key-specific array, excluding the selected key-specific arrays, with the query-specific array;
forming a target set of objects to include the query-specific array and a subset of at least one key-specific array having an intersection level with the query-specific array exceeding a predefined lower bound.

2. The method of claim 1 wherein said forming of a query-specific array comprises determining a union of said selected key-specific arrays;

3. The method of claim 1 wherein said forming of a query-specific array comprises including in said query-specific array only each object of said selected key-specific arrays that belongs to at least two key-specific arrays of said selected key-specific arrays.

4. The method of claim 1 wherein said determining an intersection level comprises:
computing a critical number of samples according to cardinality of said each key-specific array;
counting a first number of intersections corresponding to said critical number of samples; and
where said first number, for any key-specific array, exceeds a specified intersection lower bound:
continuing to count all intersections;
otherwise, discard said any key-specific array.

5. The method of claim 4 further comprising:
determining a ratio, denoted ρ, of said specified intersection lower bound to cardinality of said each key-specific array; and
determining said critical number as γ*=┌(logₑ η)/logₑ (1.0−ρ)┐,
η being a deciding probability, selected to be less than 0.01, that none of γ* randomly selected objects of said each key-specific array is found in the query-specific array.

6. The method of claim 4 further comprising:
determining said critical number, denoted γ, from a recursion:
π₀=1,
πⱼ←πⱼ₋₁×(1−r/(Ω−j+1)), j>0, π_{γ}<η,
where Ω denotes cardinality of said each key-specific array, and η denotes a deciding probability, selected to be less than 0.01, that none of γ randomly selected objects of said each key-specific array is found in the query-specific array.

7. The method of claim 1 wherein said ordered mapping comprises:
selecting objects of said sorted array sequentially; and
for each selected object and for each indicated key in a respective object vector, inserting an identifier of a position of the object in the sorted array at a first free position of a respective key-specific array. (FIG. 39)

8. The method of claim 1 wherein said determining said intersection level comprises:
segmenting said query-specific array and said each key-specific array into Λ buckets, each bucket corresponding to λ objects so that Λ×λ≥N;
generating a first bitmap of said query-specific array of objects;
generating a second bitmap of a selected key-specific array;
performing a logical AND operation of designated buckets of the first bitmap and corresponding buckets of the second bitmaps;
determining said intersection level based on the outcome of the AND operation.

9. The method of claim 1 wherein said determining said intersection level comprises:
initializing a first pointer to the key-specific array to 0;
initializing a second pointer to the query-specific array to 0; and
recursively implementing processes of:
comparing a first entry in the key-specific array corresponding to said first pointer with a second entry in the query-specific array corresponding to said second pointer;
advancing said first pointer subject to a determination that said first entry is less than said second entry;
advancing said second pointer subject to a determination that said second entry is less than said first entry; and
advancing said first pointer and said second pointer subject to a determination of equality of said first entry and said second entry.

10. The method of claim 1 further comprising:
ranking candidate key-specific arrays according to the levels of intersection with the query-specific array;
initializing a target set of objects as said query-specific array of objects;
determining a subset of a first key-specific array of highest intersection with the query-specific array comprising objects not included in the query-specific array;
forming a first augmented target array of objects to comprise objects of the query-specific array and said subset of a first key-specific array;
determining a subset of a second key-specific array of second highest intersection level with the query-specific array comprising objects not included in the first augmented target array; and
forming a second augmented target array of objects to comprise objects of the first augmented target array and said subset of a second key-specific array.

11. A query engine comprising:
a network interface configured to communicate with data sources and clients;
a first module configured to randomly shuffle an acquired array of objects to produce a sorted array of objects and assign a rank of each object in the sorted array as a respective global identifier;
a second module configured to perform ordered mapping of the sorted array of objects onto a set of key-specific arrays of objects so that each key-specific array contains global identifiers in an ascending order;
a third module configured to generate a query-specific array of objects corresponding to key-words specified in a query;
a fourth module configured to determine candidate key-specific arrays of objects based on intersection with said query-specific array of objects;
a fifth module configured to form a set of target objects combining the query-specific array and selected candidate key-specific arrays of objects;
a memory device storing the sorted array of objects, respective object vectors, and the key-specific arrays of objects; and
at least one processor coupled to said network interface, first module, second module, third module, fourth module, and fifth module.

12. The query engine of claim 11 wherein said first module:
generates unique random integers, each occurring once, in the range 0 to (N−1);
uses the m^{th}-generated random integer, 0≤m<N, to index said acquired array of objects to read an original identifier of a respective object; and
writes said original identifier in position m of the sorted array of object, m becoming said respective global identifier.

13. The query engine of claim 11 wherein, to perform said ordered mapping, said second module:
selects objects of said sorted array sequentially; and
for each selected object, and for each indicated key in a respective object vector, inserts an identifier of a position of said each selected object in the sorted array at a first free position of a respective key-specific array.

14. The query engine of claim 11 wherein, to generate said query-specific array of objects, said third module determines one of:
a union of said selected key-specific arrays of objects observing the ascending order of global identifiers; and
said union excluding each object that belongs to only one key-specific array of said selected key-specific arrays of objects.

15. The query engine of claim 11 wherein, to determine candidate key-specific arrays of objects, said fourth module:
determines a critical number of samples according to cardinality of said each key-specific array;
counts a first number of intersections corresponding to said critical number of samples; and
where said first number, for any key-specific array, exceeds a specified intersection lower bound:
marks said any key-specific array as a candidate key-specific array;
otherwise, discard said any key-specific array.

16. The query engine of claim 15 further comprising a sixth module configured to determine said critical number of samples, denoted γ*, as:
γ*=┌(logₑ η)/logₑ(1.0−ρ)┐,
ρ being a ratio of said specified intersection lower bound to cardinality of said each key-specific array, and η being a deciding probability, selected to be less than 0.01, that none of γ* randomly selected objects of said each key-specific array is found in the query-specific array.

17. The query engine of claim 16 wherein sixth module is further configured to alternatively determine said critical number, from a recursion:
π₀=1,
πⱼ←πⱼ₋₁×(1−r/(Ω−j+1)), j>0, π_{γ}<η,
where Ω denotes cardinality of said each key-specific array, and η denotes a deciding probability, selected to be less than 0.01, that none of γ randomly selected objects of said each key-specific array is found in the query-specific array.

18. The query engine of claim 11 wherein said fourth module is further configured to:
segment each array of objects into Λ buckets, each bucket corresponding to λ objects so that Λ×λ≥N, N being a total number of objects of said acquired array of objects;
generate a first bitmap of said query-specific array of objects;
generate a second bitmap of a selected key-specific array of said set of key-specific arrays;
performs a logical AND operation of designated buckets of the first bitmap and corresponding buckets of the second bitmap; determine cardinality of an intersection set
determine an intersection level based on the outcome of the AND operation.

19. The query engine of claim 11 wherein, in order to determine an intersection level of a key-specific array, of said set of key-specific arrays, with said query-specific array, said fourth module is further configured to:
initialize a first pointer to the key-specific array to 0;
initialize a second pointer to the query-specific array to 0; and
recursively:
compare a first entry in the key-specific array corresponding to said first pointer with a second entry in the query-specific array corresponding to said second pointer;
advance said first pointer subject to a determination that said first entry is less than said second entry;
advance said second pointer subject to a determination that said second entry is less than said first entry; and
advance said first pointer and said second pointer subject to a determination of equality of said first entry and said second entry.

20. The query engine of claim 11 wherein, to form said set of target objects, said fifth module
ranks said candidate key-specific arrays according to levels of intersection with the query-specific array; and
determines a union of said query-specific array and at least one of said candidate key-specific arrays selected according to rank.
